(19) United States
(12) Patent Application Publication
(10) Pub. No.: US 2025/0259418 A1
(43) Pub. Date: Aug. 14, 2025

(54) IMAGE INSPECTION DEVICE

(71) Applicant: Keyence Corporation, Osaka (JP)

(72) Inventors: Keisuke FUKUTA, Osaka (JP); Daisuke YAMAMOTO, Osaka (JP); Yuichiro HIDA, Osaka (JP)

(73) Assignee: Keyence Corporation, Osaka (JP)

(21) Appl. No.: 19/037,345

(22) Filed: Jan. 27, 2025

(30) Foreign Application Priority Data
Feb. 8, 2024 (JP) 2024-017573
Mar. 18, 2024 (JP) 2024-042647

(51) Int. Cl. G06V 10/764; G06V 10/25; G06V 10/774

(52) U.S. Cl. CPC G06V 10/764; G06V 10/25; G06V 10/774; G06V 2201/07

(57) ABSTRACT

An image inspection device includes control unit configured to execute a pre-trained model to detect a target object in an input image data. The control unit is configured to function as a learning data setting unit configured to set learning data for on-site learning of the pre-trained model and a learning data generation unit configured to generate the learning data based on settings. The learning data setting unit is configured to estimate a first candidate region in a setting image and display the first candidate region, to receive a re-estimation instruction, to estimate, upon the re-estimation instruction, a second candidate region which position is different from the position of the first candidate region. The learning data generation unit generates the learning data based on the first candidate region and the second candidate region.

### CROSS-REFERENCE TO RELATED APPLICATIONS

The present application claims foreign priority based on Japanese Patent Application No. 2024-017573, filed Feb. 8, 2024 and No. 2024-042647, filed Mar. 18, 2024 the contents of which are incorporated herein by references.

### BACKGROUND OF THE INVENTION

### 1. TECHNICAL FIELD

The present disclosure relates to an image inspection device capable of executing a trained model.

### 2. DESCRIPTION OF THE RELATED ART

For example, in the FA industry, image inspection devices that replace the process of human visual inspection of workpieces are widely known. The image inspection device captures workpiece images and judges the captured images based on certain criteria. When the image inspection device is an image sensor, the judgment result is output to external devices such as a programmable logic controller (PLC) via I/O output.

When the criteria used for the judgment of the image inspection device are based on certain image features, even changes in image features that do not affect the results of visual inspection by humans may potentially influence the judgment results of the image inspection device.

Therefore, in order to obtain judgment results closer to those of visual inspection, an image inspection device utilizing an image recognition model obtained through machine learning is known, for example, as disclosed in JP 2020-187072 A. In the image inspection device of JP 2020-187072 A, a learning unit is generated that identifies good product images and defective product images by learning good product images with attributes assigned as good products and defective product images with attributes assigned as defective products, and it is configured to input newly acquired images into the learning unit during operation to perform quality judgment.

### SUMMARY OF THE INVENTION

By the way, a large amount of image data is required to create an image recognition model obtained through machine learning, and it is difficult for each user to collect the necessary image data, or the user's burden increases.

Therefore, the image inspection device of Patent Literature 1 has a function to present learning candidate images as an aid for creating learning data. To enhance the learning of the classifier (learning accuracy and learning efficiency), it is preferable to instruct which class the data close to the class boundary (good/bad) belongs to. To assist in generating learning data that can provide such instruction, the auxiliary function of Patent Literature 1 presents image data close to the class boundary.

When there is one inspection area for the imaging area, the difficulty in generating appropriate learning data is in selecting the appropriate image data. The annotation for that image data can simply ask the user whether it is a “good product” or a “defective product” by presenting the captured image or the captured image trimmed according to the inspection area, so the difficulty is relatively low.

In contrast, when it is necessary to make multiple annotations on captured images, the difficulty of annotation is relatively high. In particular, when learning areas that the user did not actively annotate as learning data, all areas that should be annotated need to be annotated. Such annotation tasks are cumbersome for the user.

The present disclosure is made in consideration of such points, and its purpose is to enhance learning accuracy and learning efficiency by making it easy to perform annotations at multiple locations.

According to one embodiment, an image inspection device is in which a pre-trained model is executed to detect a target object in an input image data is executed. The image inspection device is equipped with a control unit that executes the pre-trained model and functions as a learning data setting unit that sets learning data for on-site learning of the pre-trained model, and a learning execution unit that executes updating of the pre-trained model based on the learning data.

The pre-trained model includes a feature extraction unit that extracts a feature from the input image data, the feature indicating a characteristic of an image data, and a classification unit that outputs a class to which an image area of the image data belongs based on the feature to detect the target object in the image data, the feature being extracted by the feature extraction unit.

The learning data setting unit includes a setting screen display unit that displays a setting screen including a setting image display area for displaying a setting image on a display device, a candidate region estimation unit that estimates a candidate region of the setting image, and a learning data generation unit that generates the learning data based on the setting image and the estimated candidate region.

The candidate region estimation unit estimates a second candidate region when a re-estimation instruction is received while the setting screen display unit is displaying the position of a first candidate region superimposed on the setting image, the first candidate region being estimated by the candidate region estimation unit, the re-estimation instruction being an instruction to execute an estimation of the candidate region, and the second candidate region being estimated such that the second candidate region being different from the first candidate region. The learning data generation unit generates the learning data based on the setting image, the first candidate region, and the second candidate region. The learning execution unit updates the pre-trained model to classify the candidate region into the class of the target object based on the learning data.

According to this configuration, the image inspection device estimates a second candidate region as a region other than the first candidate region when the candidate region estimation unit receives an instruction to execute the estimation of the learning candidate region after estimating the first candidate region. As a result, when it is necessary to make multiple annotations on the setting image data, the candidate region estimation unit can estimate multiple learning candidate regions, so that the necessary multiple annotations are automatically executed without the user having to perform multiple annotations. In other words, learning data that can enhance learning accuracy and learning efficiency can be easily obtained. Furthermore, the image inspection device trains a learned model to classify the features of pixels corresponding to multiple learning candidate regions into classes of target objects, thereby improving learning accuracy and learning efficiency without burdening the user.

The setting screen display unit can display the second candidate region in a manner different from the first candidate region after estimating the learning candidate region as the second candidate region. That is, the area estimated as the first candidate region and the second candidate region are displayed in a distinguishable manner. In particular, when the image inspection device determines the first candidate region as the learning area based on the start of estimating the learning candidate region as the second candidate region, the user can distinguish the subsequently estimated second candidate region from the first candidate region, making it easier for the user to understand that the second candidate region has been automatically estimated.

The learning data setting unit can accept user-designated learning areas based on user designation of the setting image data displayed in the setting image display area. The setting screen display unit can display the user-designated learning area and the learning candidate area in different manners, allowing the user to distinguish between the learning candidate area and the user-designated learning area.

The learning data setting unit can accept a deletion instruction for the learning candidate region displayed by the setting screen display unit and retain the corresponding learning candidate region as a deletion setting position. In this case, the candidate region estimation unit estimates the learning candidate region so that the position of the deletion setting position is not the same as the learning candidate region, so that a learning candidate region that has been deleted once will not be presented again as a learning candidate region, and there is no need to delete it again.

The candidate region estimation unit estimates a region having similar features to the reference feature quantity as the first candidate region, and when receiving an instruction to execute the estimation of the learning candidate region, it can estimate a region having similar features to the feature quantity corresponding to the displayed first candidate region as the second candidate region. This makes it easier for the estimation of the learning candidate region to align with the user's intention.

The candidate region estimation unit can also estimate a third learning candidate region corresponding to a class feature quantity similar to the reference class feature quantity within a certain range based on the feature quantities for each pixel after estimating the second candidate region. In this case, the candidate region estimation unit can estimate the third learning candidate region using the class feature quantity of the second candidate region as the reference class feature quantity. Furthermore, the candidate region estimation unit can also estimate the third learning candidate region by expanding the certain range.

The learning execution unit can also train the trained model to classify the first candidate region into the class of the target object and to classify regions other than the first candidate region into the class of the background. In this case, the learning execution unit can learn a boundary that separates the class of the target object from the class of the background. As a result, the trained model can detect the target object in the image of the inference image data based on the feature quantity for each pixel and the boundary.

As described above, the candidate region estimation unit estimates the first candidate region and the second candidate region, and since the estimated first candidate region and the second candidate region can be reflected in the learning data, it is possible to easily perform annotations at multiple locations, as well as to improve learning accuracy and learning efficiency.

### BRIEF DESCRIPTION OF THE DRAWINGS

FIG. 1 is a diagram explaining the operation of the image inspection device according to an embodiment of the present invention.

FIG. 2 is a hardware configuration diagram of the image inspection device.

FIG. 3A is a functional block diagram within the DSP.

FIG. 3B is a conceptual diagram when the learning tool execution unit executes the AI object detection tool.

FIG. 4 is a flowchart showing an example of the procedure during the setting of the image inspection device.

FIG. 5 is a flowchart showing an example of the procedure during the setting of the inspection tool.

FIG. 6 is a flowchart showing an example of the procedure for estimating the learning candidate area.

FIG. 7 is a diagram showing an example of the display of the setting screen.

FIG. 8 is a diagram showing an example of the display of the tool setting items.

FIG. 9 is a diagram showing an example of the display of the first candidate area.

FIG. 10 is a diagram showing an example of the display of the setting area determination window.

FIG. 11 is a diagram explaining an outline of the method for estimating the learning candidate area.

FIG. 12 is a diagram showing an example of the image used for learning execution.

FIG. 13 is a flowchart showing an example of the procedure during the inspection execution.

FIG. 14 is a diagram showing an example of the tool setting screen.

FIG. 15 is a diagram showing an example of the tool selection window.

FIG. 16 is a diagram showing an example of the screen displayed when starting the learning settings.

FIG. 17 is a diagram showing an example of the screen displayed during box setting.

FIG. 18 is a diagram showing an example of the screen displayed when setting the count target.

FIG. 19 is a diagram showing an example of the screen displayed when the count target is automatically detected.

FIG. 20 is a diagram showing an example of a rotated learning image.

FIG. 21 is a diagram showing an example of a warning display window.

FIG. 22 is a diagram showing an example of a window for setting the upper and lower limits of the count number.

FIG. 23 is a diagram showing an example of a test screen.

FIG. 24 is a diagram showing an example of the settings window for extended functions.

FIG. 25 is a diagram showing an example of the screen displayed during operation.

FIG. 26 is a diagram showing an example of the display of the judgment result by the total tool.

FIG. 27 is a diagram showing the case of setting a tool in the middle section.

FIG. 28 is a diagram showing the case where the search range is set in the middle section by the user.

FIG. 29 is a diagram showing an example of the screen where the count target is automatically detected when the middle section is the search range.

FIG. 30 is a diagram showing an example of a warning display.

FIG. 31 is a diagram showing the case of setting multiple learning count tools.

FIG. 32 is a diagram showing the case of selecting the learning count tool that is subject to the total tool.

FIG. 33 is a diagram showing an example of the screen displayed after the setting of the total tool is completed.

FIG. 34 is a diagram showing an example of the screen displayed during the operation of the total tool.

FIG. 35 is a diagram showing the case where the learning count tool in the upper section is selected.

FIG. 36 is a diagram explaining the function to delete duplicate detection between tools.

FIG. 37 is a diagram showing the case where a normally arranged work image is input.

FIG. 38 is a diagram showing the case where some works are missing.

FIG. 39 is a diagram explaining the case of setting missing detection.

FIG. 40 is a diagram showing the number assignment setting window.

FIG. 41 is a diagram explaining the method of missing detection.

### DETAILED DESCRIPTION

The following describes in detail the embodiments of the present invention based on the drawings. The description of the preferred embodiments below is essentially illustrative and is not intended to limit the present invention, its applications, or its uses.

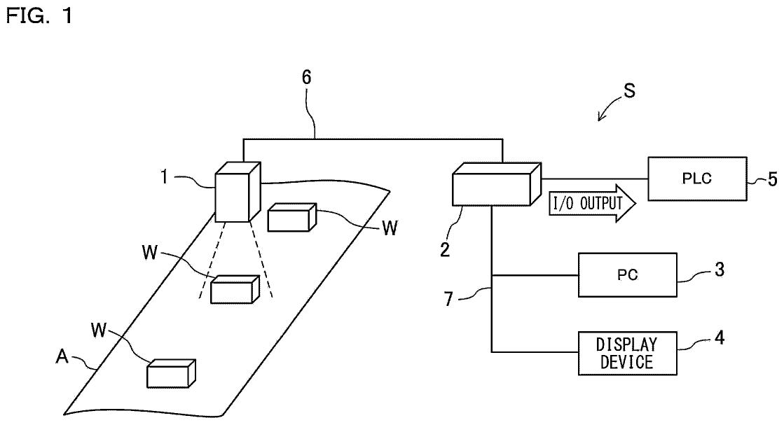

FIG. 1 is a diagram explaining the operation of the image inspection device S according to an embodiment of the present invention. The image inspection device S captures an object W conveyed by the conveying means A according to the imaging settings to acquire inference image data, detects the object W in the acquired inference image data, and outputs the detection result to an external device. The external device can include, for example, a Programmable Logic Controller (PLC) 5, but it may also be a device other than PLC 5. The PLC 5 controls the conveying means A to separate the storage destination of the object W based on the received detection result. The following explanation will describe the case where the external device is PLC 5. Note that the object W may also be an object that is not conveyed by the conveying means A. Furthermore, in the following explanation, the object is also referred to as a target object.

The image inspection device S is equipped with an imaging unit 1 for capturing the work W, a control unit 2 to which inference image data captured by the imaging unit 1 is input, a PC (personal computer) 3 for setting the image inspection device S, and a display device 4 for displaying the setting screen, selection screen, work images, detection results, and the like. The control unit 2 is capable of executing a trained model that detects the work W in the image of the input inference image data. The control unit 2 executes output to the PLC 5 according to the detection results from the trained model.

The image inspection device S is sometimes used to inspect the work W from various angles at various points of a manufacturing device or manufacturing line, for example. Therefore, there may be multiple image inspection devices S installed in a single manufacturing device or a single manufacturing line, and it is conceivable that sufficient installation space and power supply cannot be secured. Thus, the image inspection device S requires miniaturization to fit the installation space and power saving to match the power supply, and to satisfy these requirements, the image inspection device S according to this embodiment is configured without a GPU. In other words, the control unit 2 can execute a trained model that has been trained to the extent that basic detection of the work W is possible, but it is possible to achieve the desired detection accuracy without the user performing advanced additional learning that would recommend GPU usage. Furthermore, the fact that the user does not need to perform advanced learning means that the user does not need to prepare a GPU tailored for learning, which can shorten the time required for learning. It is also possible to install and operate a single image inspection device S on a manufacturing device or manufacturing line. Additionally, the image inspection device S can also be referred to as an image sensor.

### Structure of Imaging Unit

The Imaging Unit 1 is configured separately from the Control Unit 2 and is installed so that it can capture the Work W from a desired direction. The Work W is sequentially conveyed by the Conveying Means A into the imaging field of the Imaging Unit 1.

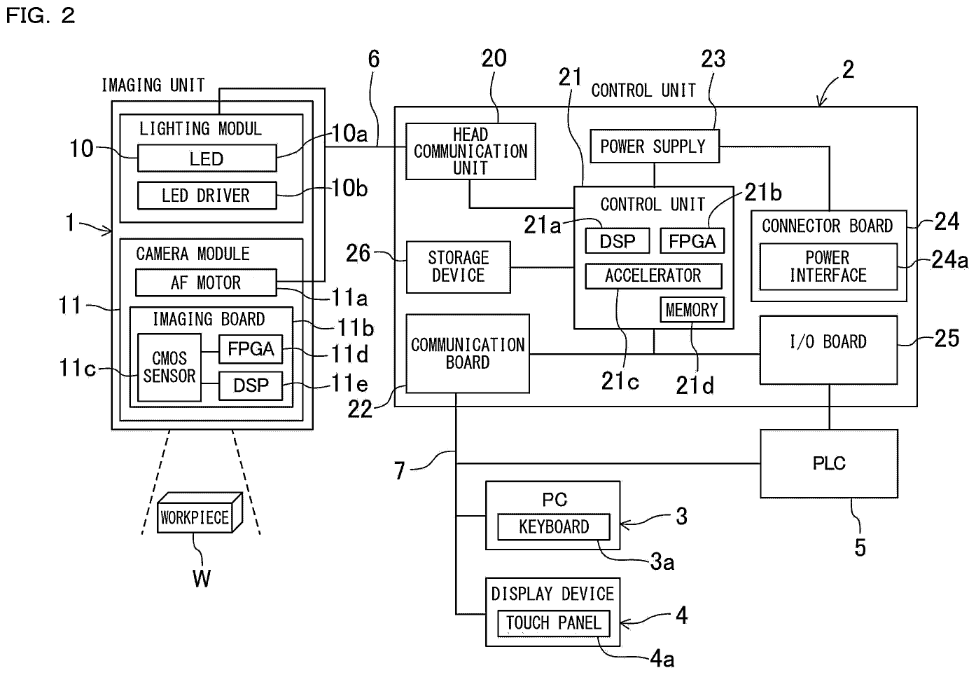

As shown in FIG. 2, the imaging unit 1 includes a lighting module 10 for illuminating the work W and a camera module 11 for capturing the work W illuminated by the lighting module 10.

The lighting module 10 includes an LED (light emitting diode) 10a that irradiates light toward the work W, and an LED driver 10b that controls the light amount and light emission timing of the LED 10a. The LED driver 10b is connected to the head communication unit 20 of the control unit 2 (described later) and is controlled by the control unit 2's control unit 21 (described later).

The camera module 11 includes an AF motor 11a and an imaging board 11b. The AF motor 11a is a component for automatically focusing on the work W by driving a focusing lens of an optical system (not shown). The method of automatic focus is not particularly limited, and examples such as the contrast method can be mentioned.

The imaging board 11b is equipped with a CMOS sensor 11c, an FPGA 11d, and a DSP 11e. The CMOS sensor 11c is an image sensor that receives reflected light reflected from the work W, which is irradiated by the LED 10a. This CMOS sensor 11c is connected to the head communication unit 20 of the control unit 2 and is controlled by the control unit 2's control unit 21 to perform exposure processing for a predetermined time at a predetermined timing.

FPGA 11d is a processing device capable of changing the internal processing content. DSP 11e is a signal processing device. The light reception amount signal of the light receiving element possessed by CMOS sensor 11c is output to FPGA 11d for processing, and is also output to DSP 11e for processing. The processing by FPGA 11d and DSP 11e is not particularly limited, but various filter processing can be mentioned as an example. The image data processed by FPGA 11d and DSP 11e is transmitted from imaging unit 1 to control unit 2.

The imaging unit 1 and the control unit 2 are connected via the communication cable 6. Therefore, the control unit 2 can be installed at a location away from the installation location of the imaging unit 1.

### Structure of PC

PC 3 is composed of a general-purpose personal computer or the like. In this example, PC 3 becomes usable by installing a predetermined program on the personal computer. PC 3 includes input devices such as a keyboard 3a and a mouse (not shown). The user of the image inspection device S can perform setting operations and selection operations of the image inspection device S by operating the input devices of PC 3. Specific setting operations and selection operations will be described later.

The communication board 22 of PC 3 and the control unit 2 are connected to each other in a communicable manner, and information based on the setting operation by the user is transmitted from PC 3 to the control unit 2. In addition, image data of the work W and inspection results output from the control unit 2 can be received by PC 3. PC 3 and the control unit 2 are connected via communication cable 7. Therefore, PC 3 can be installed at a location away from the installation location of the control unit 2.

### Structure of Display Device 4

The display device 4 is composed of, for example, a liquid crystal display or an organic EL display. In this example, the display device 4 includes a touch panel 4a. The touch panel 4a is a member capable of detecting operations by the user's finger. The form of the touch panel 4a is not particularly limited, and examples include capacitive type, infrared type, etc. The display device 4 and the communication board 22 of the control unit 2 are connected to each other in a manner that allows mutual communication. The operation information of the touch panel 4a by the user is transmitted from the display device 4 to the control unit 2. In addition, image data of the work W output from the control unit 2 can be received by the display device 4. The display device 4 and the control unit 2 are connected via a communication cable 7. Therefore, the display device 4 can be installed at a location away from the installation location of the control unit 2.

Moreover, PC 3 and display device 4 may be configured as a single unit. For example, display device 4 may be configured with the display device possessed by PC 3. In this case, the main body of PC 3 and display device 4 may be integrated or may be separate. In this example, communication board 22 and PLC 5 are connected via communication cable 7.

### Configuration of Control Unit 2

As shown in FIG. 2, the control unit 2 includes a head communication unit 20, a control unit 21, a communication board 22, a power supply 23, a connector board 24, an I/O board 25, and a storage device (storage unit) 26. The head communication unit 20 is connected to the control unit 21 and is the part that performs mutual communication between the control unit 21 and the imaging unit 1. The control signal of the imaging unit 1 output from the control unit 21 is transmitted to the imaging unit 1 via the head communication unit 20. The control signal of the imaging unit 1 includes a signal that controls the light emission timing and light emission amount of LED 10a, and a signal that controls the AF motor 11a and the imaging board 11b. In addition, the image data obtained by the imaging unit 1 is transmitted to the control unit 21 via the head communication unit 20 after being output from the imaging unit 1.

The control unit 21 includes a DSP 21a and an FPGA 21b that perform various signal processing, an accelerator 21c for accelerating processing, and a memory 21d made of RAM, ROM, etc. The specific configuration of the control unit 21 will be described later.

The communication board 22 is connected to the control unit 21 and is a component that performs mutual communication between the control unit 21, PC 3, display device 4, and PLC 5.

The connector board 24 includes a power interface 24a. The power interface 24a is connected to a power cable (not shown) for supplying power from the outside. The connector board 24 is connected to the power supply 23, and the power supplied to the power interface 24a from the outside is adjusted to a predetermined voltage by the power supply 23 before being supplied to the control unit 21. The power supplied to the control unit 21 is supplied to the imaging unit 1 via the head communication unit 20.

The I/O board 25 is connected to the control unit 21. The inspection result output from the control unit 21 is input to the PLC 5 via the I/O board 25.

### Details of DSP21a

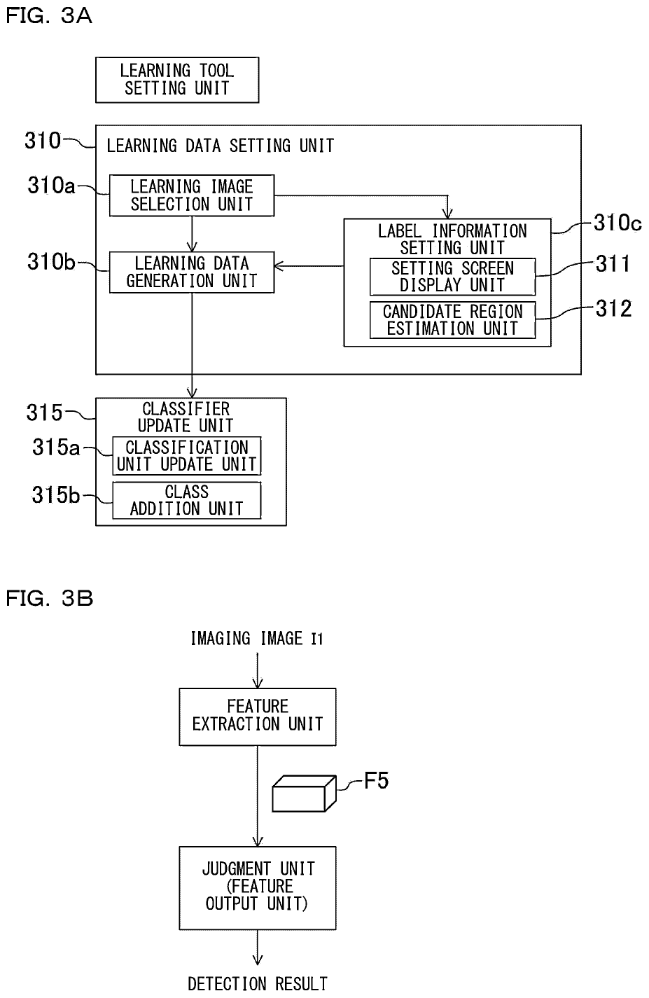

FIG. 3A is a functional block diagram of DSP21a possessed by the control unit 2. DSP21a has an imaging setting unit, a rule-based related function block, and a detection task-related function block based on a trained model.

The imaging setting unit is a part that sets the imaging setting parameters and reflects the set imaging setting parameters during the imaging of the work W. The imaging setting parameters include multiple parameters such as the timing of illumination by the lighting module 10, brightness (light emission amount), exposure time by the camera module 11, and focus (focal position) of the camera module 11. When setting the image inspection device S, the imaging setting unit displays a GUI (Graphical User Interface) related to the setting of the imaging setting parameters on the display device 4. Although not shown, the GUI related to the setting of the imaging setting parameters has areas where the brightness of the illumination, exposure time, focus, etc. can be set individually. When the user inputs each parameter on the GUI using a touch panel 4a or a keyboard 3a, the imaging setting unit accepts the setting operation by the user and outputs each parameter to, for example, the storage device 26 to store it in the storage device 26. It is possible to read each parameter from the storage device 26 as needed.

When acquiring image data of the work W, the imaging setting unit outputs the imaging setting data, including the imaging setting parameters, to the camera module 11. When the camera module 11 receives the imaging setting data, it sets the imaging setting parameters contained in the received imaging setting data to be reflected during imaging within the camera module 11. When the camera module 11 receives the imaging trigger signal, it illuminates the work W according to the imaging setting parameters and captures the image data of the work W.

The rule-based related function block has a parameter setting unit and a tool selection unit. The tool selection unit is a part that allows the user to select tools to be used for inspection. When setting the image inspection device S, the tool selection unit displays a GUI related to tool selection on the display device 4. Although not shown, the GUI related to tool selection has an area where the user can select the desired tool from multiple tools. When the user selects any tool on the GUI using a touch panel 4a or a keyboard 3a, the tool selection unit accepts the selection operation by the user and outputs the selected tool to, for example, the storage device 26 to store it in the storage device 26. It is possible to load the selected tool from the storage device 26 as needed.

The information regarding the tool selected in the tool selection unit is output to the parameter setting unit as selected tool information. When setting the image inspection device S, the parameter setting unit displays a GUI (Graphical User Interface) related to the setting of tool parameters on the display device 4. The tool parameters are parameters that can be set for each tool. When the user sets the tool parameters on the GUI using the touch panel 4a or keyboard 3a, the parameter setting unit accepts the setting operation by that user and outputs the tool parameters to, for example, the storage device 26 to store them in the storage device 26. It is possible to read the tool parameters from the storage device 26 as needed.

The detection task-related function block includes a learning data setting unit 310, a feature extraction unit, and an inspection operation unit. The learning data setting unit 310 performs settings related to the inspection of captured images and reflects the settings related to the inspection. When setting the image inspection device S, the learning data setting unit 310 displays a GUI for performing settings related to the inspection of captured images on the display device 4. When the user inputs each parameter on the GUI using a touch panel 4a or a keyboard 3a, the learning data setting unit 310 accepts the setting operation by the user and outputs each setting to, for example, the storage device 26 to store it in the corresponding storage device 26.

The settings by the learning data setting unit 310 include, broadly speaking, the setting of the inspection range of the captured image, the setting referred to as learning, and the setting of the specifications for inspection based on the judgment results. The setting of the inspection range can be executed by the master image registration unit and the inspection window setting unit. In addition, the setting referred to as learning can be executed by the learning data setting unit 310 and the classifier update unit 315. Furthermore, the setting of the specifications for inspection based on the judgment results can be executed by the inspection condition setting unit. When these settings are made, the learning data setting unit 310 reflects the settings during inspection execution (when the image inspection device S is in operation).

The master image registration unit is a part that registers the captured image as a master image. Specifically, the master image registration unit presents the captured image to the user by incorporating it into the GUI and displaying it on the display device 4. When the user wants to register the captured image displayed on the display device 4 as a master image, they perform the registration operation using a touch panel 4a or a keyboard 3a. The master image registration unit registers the captured image for which the registration operation has been performed by the user as a master image, and outputs it to, for example, the storage device 26 to store it in that storage device 26.

The inspection window setting unit accepts instructions regarding the position, range, shape, etc. of the inspection window for the captured image. Specifically, the inspection window setting unit displays a GUI for setting the inspection window on the display device 4. When the user inputs the position, range, shape, etc. of the inspection window on the GUI using a touch panel 4a or a keyboard 3a, the inspection window setting unit accepts the setting operation by the user and outputs it as information regarding the inspection window to, for example, the storage device 26, and stores it in the storage device 26. The inspection window setting unit reflects the setting of the inspection range based on the positional relationship of the inspection window to the captured image.

The learning data setting unit 310 is a part that sets the learning data D1 for updating the classifier, which is a pre-trained model. Specifically, the learning data setting unit 310 includes a learning image selection unit 310a, a learning data generation unit 310b, and a label information setting unit 310c, where the label information setting unit 310c includes a setting screen display unit 311 and a candidate region estimation unit 312. As will be described in detail later, the setting screen display unit 311 is a part that displays a setting screen including a setting image display area that displays the setting image on the display device 4, and the candidate region estimation unit 312 is a part that estimates candidate regions in the setting image data. In this way, the control unit 21 functions as the learning data setting unit 310 that sets the learning data D1 for on-site learning of the pre-trained model while controlling the computation processing by the pre-trained model.

One class as the determination result of AI object detection is the work W, that is, the “target object (foreground)” and the other is the part other than the work W, that is, the “background”. In other words, all image areas included in a certain captured image are classified as either “foreground” or “background”. Therefore, after displaying the captured image on the display device 4, when receiving the specification of the position of the work W in the captured image from the user, the specified position in the captured image becomes the “target object (foreground)” class, and the position that was not specified in the captured image becomes the “background” class. In this way, the learning data setting unit 310 acquires two types of label information by receiving the specification of the position of the work W in the captured image from the user and stores the acquired label information in the storage device 26 or the like. When this label information is combined with the image data displayed when the label information is set, the image area and the label corresponding to that image area are specified. Therefore, information related to the combination of the image data of the displayed captured image and the label information assigned to the captured image data is output from the learning data setting unit 310 to the learning data generation unit 310b.

At this time, all positions that are not designated as the “target object (foreground)” class in the captured image are processed as the “background” class. Therefore, it is necessary to specify positions corresponding to the “foreground” class without omission, and the displayed GUI and related functions are configured to assist in specifying the positions of the “foreground” class without omission.

The learning data generation unit 310b is a part that acquires each piece of information from the learning image selection unit 310a and the label information setting unit 310c. As will be described in detail later, the learning data generation unit 310b generates learning data D1 based on the setting image data of the setting image I3, which is selected as the learning image and displayed on the setting screen, and the candidate region estimated by the candidate region estimation unit 312. If the candidate region estimated by the candidate region estimation unit 312 includes, for example, a first candidate region and a second candidate region, the learning data generation unit 310b generates learning data DI based on the setting image data, the first candidate region, and the second candidate region.

The learning data generation unit 310b outputs the generated learning data D1 to the classifier update unit 315. The classifier update unit 315 is a learning execution unit that performs on-site learning based on the learning data D1 received from the learning data generation unit 310b. Thus, the control unit 21 also functions as a learning execution unit that performs additional learning based on the learning data.

The classifier update unit 315 includes a classifier update part 315a and a class addition part 315b. The classifier update unit 315 updates the judgment unit used in inspection by implementing a predetermined update method based on the received learning data. In other words, the classifier update unit 315 performs learning using the learning data.

The classifier update unit 315a updates the SVM (Support Vector Machine) as a classifier in the “learning tool” mode. Specifically, the classifier update unit 315a inputs image data (captured image) into the feature extractor controlled by the feature extraction unit to obtain a feature vector. As a result, the learning data group is treated as a group of “combinations of feature vector and class labels corresponding to each feature vector.” Based on this combination group, a boundary surface is generated so that each class identified by the class labels in the feature space where the feature vectors are mapped is distinguished. When additional learning data is present, the boundary surface is readjusted so that the additional feature vectors in the feature space are classified into the classes associated with the additional feature vectors.

The classifier update unit 315a updates the SVM as a classifier even in the case of AI object detection mode. The difference compared to the “learning tool” mode is that it inputs the region image to obtain the feature vector, and otherwise performs the update of the classifier in the same manner as in the “learning tool” mode.

The inspection condition setting unit is a part that sets when a predetermined inspection result is output based on what conditions are met by the judgment result. The inspection condition setting unit displays a GUI that allows selection of the judgment mode and setting of the judgment conditions on the display device 4. Although not shown, this GUI has an area where the judgment conditions can be set. When the user sets the judgment conditions on the GUI using a touch panel 4a or a keyboard 3a, the inspection condition setting unit accepts the setting operation of the judgment conditions by that user. As a judgment condition, for example, the condition of ‘how many detected objects are needed for the inspection result to be ‘good” can be cited when the judgment mode is AI object detection mode.

The feature extraction unit is composed of, for example, a convolutional neural network. The feature extraction unit is a part that extracts features indicating the characteristics of the image data from the input image data, and can also extract features for any position in the input image data. In addition, the feature output unit outputs the class to which the image data belongs as information indicating the characteristics of the image data based on the features extracted by the feature extraction unit, and is the part that detects the object in the image of the image data.

The feature extraction unit has an image feature extraction unit and a feature map output unit. The image feature extraction unit is a part that inputs image data (captured image) to the feature extractor to obtain a multidimensional feature vector. The feature map output unit is a part that inputs image data to the feature extractor and obtains a feature map in which feature vectors are calculated for each convolution pixel corresponding to a pixel area of a certain range in the input image data.

The inspection operation unit has a judgment unit and an inspection result output unit, and generates an inspection result based on the judgment result by the judgment unit, outputting the generated inspection result from the I/O board 25 to the PLC 5 and the like.

The judgment unit is a part that outputs judgment results based on the input features (feature vector or feature map), and it has an image classification unit and an image region classification unit.

The image classification unit classifies the feature vector into “good” class and “defective” class using a classifier (SVM) when in the “learning tool” mode, classifying the feature vector input from the image feature extraction unit. The judgment result output from the image classification unit indicates which class the image data corresponding to the feature vector belongs to.

The image area classification unit uses a classifier (SVM) to classify the feature map input from the feature map output unit into “foreground” class and “background” class in the case of AI object detection mode, classifying the feature vector of the input feature map. In the image area classification unit, the convolution pixels of the feature map are classified as either “foreground” or “background”, allowing determination of where the “foreground”, namely the work W, exists in the image data corresponding to the feature map based on this classification result.

The inspection result output unit is a part that generates and outputs inspection results based on the judgment results output from the judgment unit. In the case of the “learning tool” mode, the inspection result output unit obtains the class classification results of “good” and “defective” for the image data as the judgment results. The inspection result output unit outputs the obtained judgment results as the inspection results for the corresponding image.

The inspection result output unit has an inspection result generation unit. In the case of AI object detection mode, the inspection result generation unit obtains the determination result of where the work W exists in the image data corresponding to the input feature map based on the classification result by the image area classification unit. For example, when the inspection condition is “there are a specific number (one for search, any number for count) or more of an arbitrary target object (work W),” the inspection result generation unit outputs the inspection result based on the number of work W indicated in the determination result in the image data and can display the area corresponding to the detected work W on the target image data.

The target objects for object detection can be registered in multiple types. For example, by registering a first target object and a second target object that has a different shape, color, and size from the first target object, the inspection result generation unit obtains as a judgment result where the first target object exists in the image data and at what angle, as well as where the second target object exists in the image data and at what angle.

The inspection result output unit may generate and output further inspection results by combining multiple inspection results obtained in AI object detection mode. For example, if it is determined as “good” by the “learning tool” and there are two target objects in the image (the inspection mode is counting and the usage determination tool is AI object detection mode), it is also possible to output “good” as the inspection result.

DSP21a also has an additional learning image designation unit. When the user adds learning to the trained model, the additional learning image designation unit allows for the specification of learning images.

FIG. 3B is a conceptual diagram when the learning tool execution unit executes the AI object detection tool T2. The learning tool execution unit executes the feature extraction unit and the judgment unit as a pre-trained model.

The image data of the captured image I1 is input to the feature extraction unit executed by the learning tool execution unit. The feature extraction unit outputs the feature F5. The feature F5 is a feature map that reflects the spatial information of the captured image I1.

The feature F5 extracted by the feature extraction unit is input to the judgment unit. The judgment unit identifies and outputs the position of the target object in the captured image I1 based on the feature F5. More specifically, it compares the feature F2 indicating the target object with the features corresponding to each convolution pixel constituting the feature F5, determines the region with high similarity as the target object region, and outputs information indicating the position of the target object region in the captured image I1.

### When Setting the Image Inspection Device

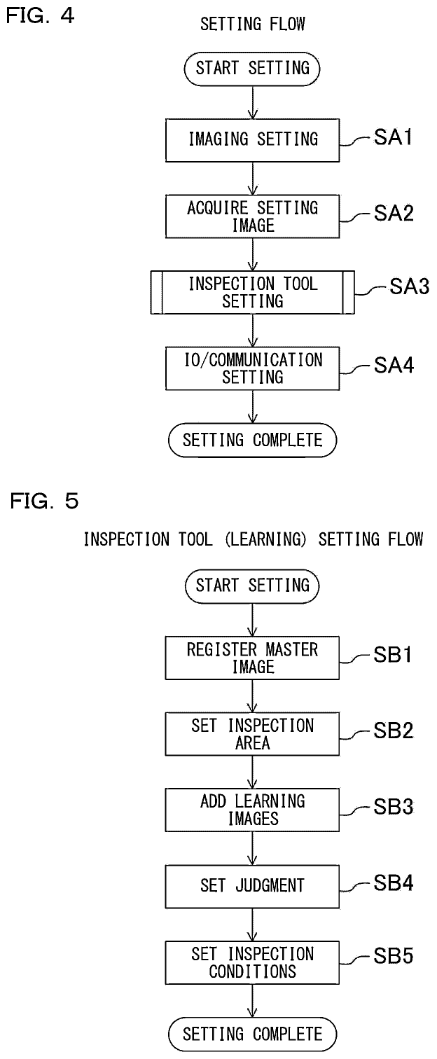

FIG. 4 is a flowchart showing the procedure for setting the image inspection device S. In step SA1 after the start, the imaging setting parameters are set by the imaging setting unit. In step SA2, the imaging setting parameters set in step SA1 are applied to execute imaging in the imaging unit 1. The image data acquired by the imaging unit 1 is stored in the storage unit 26 and treated as a master image or learning image.

In the setting of the inspection tool in step SA3, the inspection tool is set according to the judgment mode. In step SA4, input of signals from external sources, output of signals to external sources, and setting of communication, etc. are performed.

The details of Step SA3 will be explained based on the flowchart shown in FIG. 5. In Step SB1, the image obtained in Step SA2 shown in FIG. 4 is registered as a master image by the master image registration unit. In Step SB2, the inspection range is set by the inspection window setting unit on the master image registered in Step SB1.

In step SB3, a learning image is added. In the case of the “learning tool”, it is possible to simultaneously perform the addition of the learning image and the judgment setting in step SB4.

In the case of AI object detection mode and AI-OCR mode, the display of learning images on the GUI corresponds to the addition of learning images (step SB3), and the acceptance of specifications for the displayed image corresponds to the judgment setting (step SB4). The judgment setting in step SB4 generates learning data after the acceptance of specifications and repeats the process of additionally training the classifier with that learning data until completion.

In step SB5, condition settings for generating inspection results based on the judgment results are performed. For example, when count is selected as the inspection tool, it is set to determine how many areas identified as objects in AI object detection mode will output the inspection result as “good.”

### Estimation of Learning Candidate Region

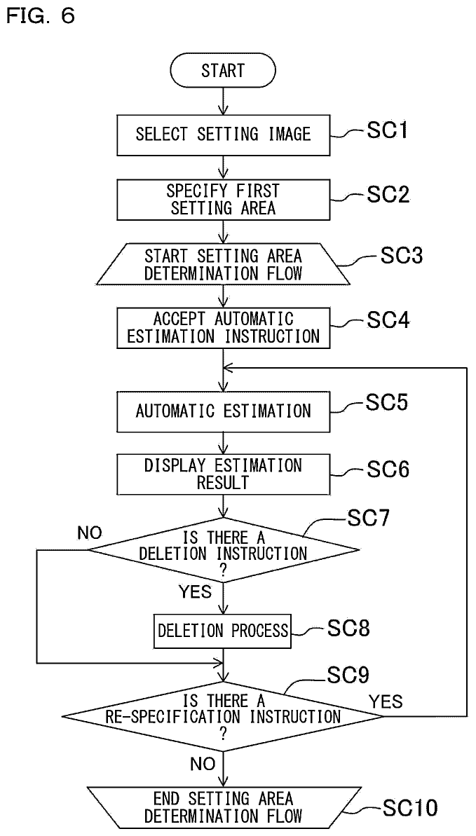

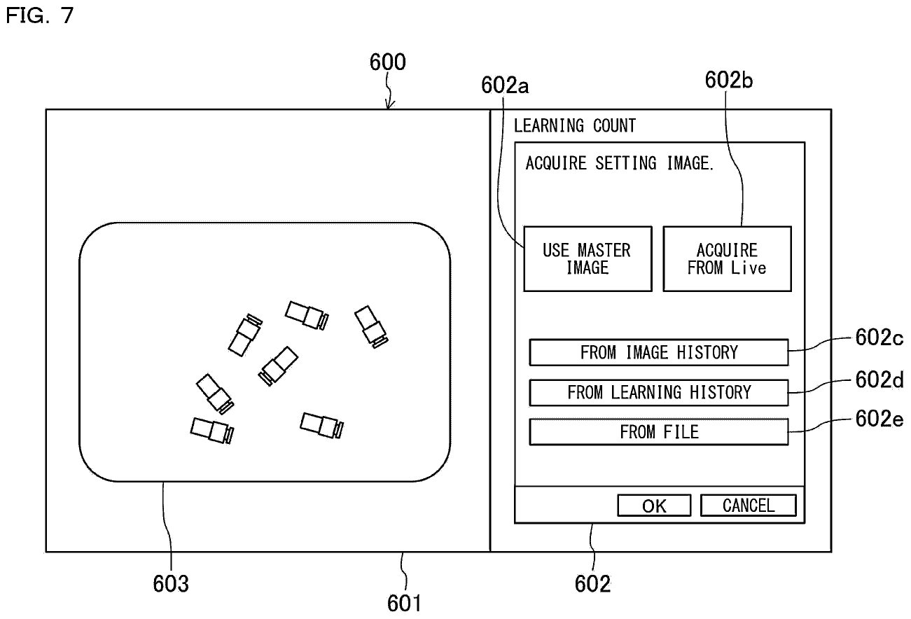

FIG. 6 is a flowchart showing the procedure when the learning data setting unit 310 estimates the candidate region. This flowchart can start after step SB2 of the flowchart shown in FIG. 5. In step SC1 corresponding to step SB3, the setting image (learning image) I3 used for estimating the candidate region is selected. Specifically, the learning data setting unit 310 displays a setting screen 600 as shown in FIG. 7 on the display device 4 via the setting screen display unit 311.

The setting screen 600 displays a setting image display area 601 where the setting image data is shown and an image acquisition window 602. The image acquisition window 602 is provided with a master image selection button 602a and a live image selection button 602b. When the learning data setting unit 310 detects that the master image selection button 602a has been operated, it sets the image data registered as the master image I2 by the master image registration unit in step SB2 shown in FIG. 5 as the setting image data, and displays the setting image I3 based on the setting image data in the setting image display area 601. In this way, the image used when setting the inspection range by the inspection window setting unit can be set as the setting image I3.

On the other hand, the learning data setting unit 310 detects that the live image selection button 602b has been operated, retrieves the image data currently being captured by the imaging unit 1 from the imaging unit 1, and uses the retrieved image data as the setting image data, displaying the setting image I3 based on this setting image data in the setting image display area 601. In this way, the live view image can also be set as the setting image I3.

The image acquisition window 602 is provided with an image history button 602c, a learning history button 603d, and a file selection button 602e. When the learning data setting unit 310 detects that the image history button 602c has been operated, it displays the images acquired by the imaging unit 1 so far in a list format on the setting screen 600 and accepts the user's selection of images. The learning data setting unit 310 displays the image selected by the user as the setting image I3 in the setting image display area 601.

The Learning Data Setting Unit 310 detects that the Learning History Button 603d has been operated, and displays the images that have been used as learning images in a list format on the setting screen 600, accepting the user's selection of learning images. The Learning Data Setting Unit 310 displays the learning image selected by the user as the Setting Image 13 in the Setting Image Display Area 601.

The learning data setting unit 310 detects that the file selection button 602e has been operated, and displays the images stored in the storage device 26 in a list format on the setting screen 600, accepting the user's selection of images. The learning data setting unit 310 displays the image selected by the user as the setting image I3 in the setting image display area 601.

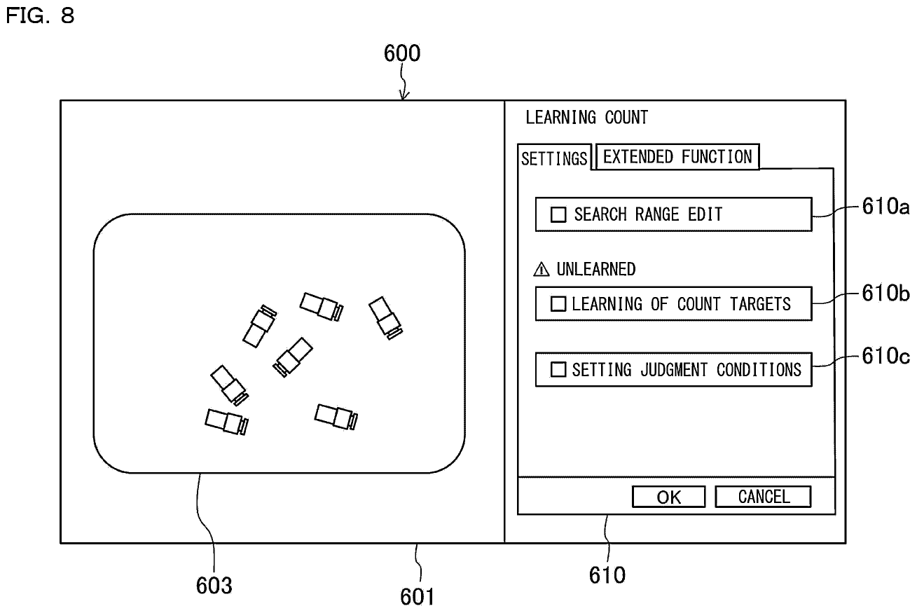

After setting the setting image I3, the learning data setting unit 310 displays a setting screen 600 as shown in FIG. 8 on the display device 4. The setting screen 600 shown in FIG. 8 includes a list display window 610 for listing tool setting items. The list display window 610 is provided with a search range edit button 610a, a learning button 610b, and a judgment condition setting button 610c. When the search range edit button 610a and the learning button 610b are operated, the learning data setting unit 310 accepts settings based on user operations regarding which range in the setting image to perform counting of the target object and object detection for counting the target object.

The learning data setting unit 310 accepts the setting of conditions for judging inspection results as a tool based on user operations when the judgment condition setting button 610c is operated. For example, if a predetermined number is set as a condition for the count of target objects, that predetermined number will be the condition for judging the inspection results.

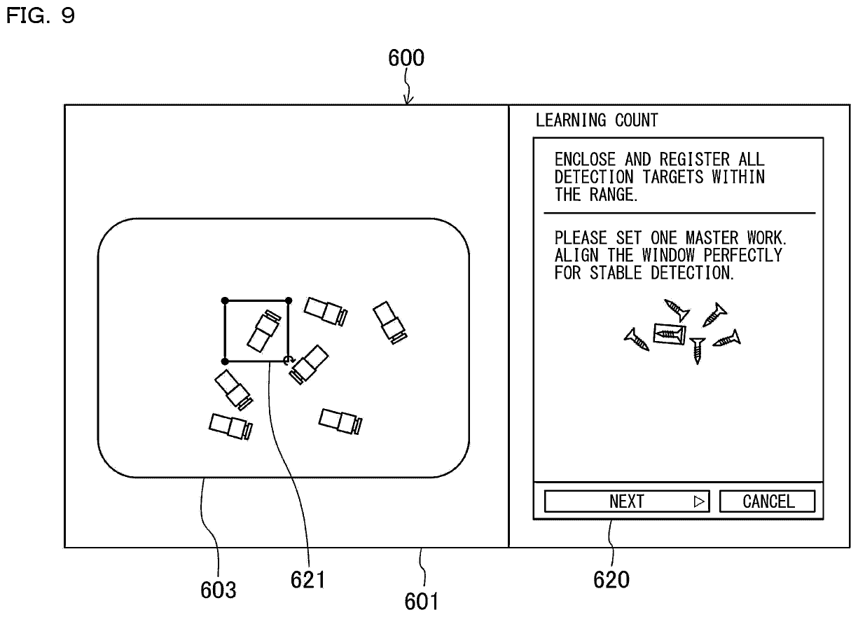

After step SC1, in step SC2, the first setting area for the setting image data set in step SC1 is specified by the label information setting unit 310c. In step SC2, the setting screen 600 shown in FIG. 9 is displayed on the display device 4. In the setting screen 600 shown in FIG. 9, a procedure display window 620 showing the procedure for specifying the setting area is displayed. In addition, in the setting image display area 601 of the setting screen 600 shown in FIG. 9, a specification box 621 for the user to specify the setting area as the first setting area is superimposed on the setting image I3. The position, size, shape, angle, etc. of the specification box 621 can be changed by the user operating a mouse or the like, and this change operation is called an editing operation. When the learning data setting unit 310 accepts the editing operation, the position, size, shape, angle, etc. of the specification box 621 on the setting image display area 601 are changed and displayed so that the editing operation is reflected. In this way, the learning data setting unit 310 can accept the specification of the first setting area through user operations on the setting image I3 displayed in the setting image display area 601.

The first setting area specified in step SC2 may be automatically detected by the learning data setting unit 310 based on features corresponding to known classes. That is, the setting image I3 displayed in the setting image display area 601 included in the setting screen may be input to a pre-trained model to obtain features for each pixel, and then the candidate region estimation unit 312 may estimate a candidate region as the first setting area in the setting image data based on the features for each pixel. At this time, the setting screen display unit 311 may superimpose a box of a different manner on the setting image I3 to enclose the estimated candidate region, which is different from the specified box 621. In other words, by displaying a box as information indicating the position of the candidate region superimposed on the setting image I3 by the setting screen display unit 311, the user can be presented with which region the candidate region estimated by the pre-trained model corresponds to. Furthermore, the information indicating the position of the first setting area is not limited to the specified box 621; for example, it may also include displaying the first setting area more faintly or more prominently than other regions. Additionally, the method of specifying the first setting area is not limited to using the specified box 621. For example, it may be a configuration in which the label information setting unit 310c estimates the size and angle of the setting area based on a portion of the area that the user wishes to specify as the setting area.

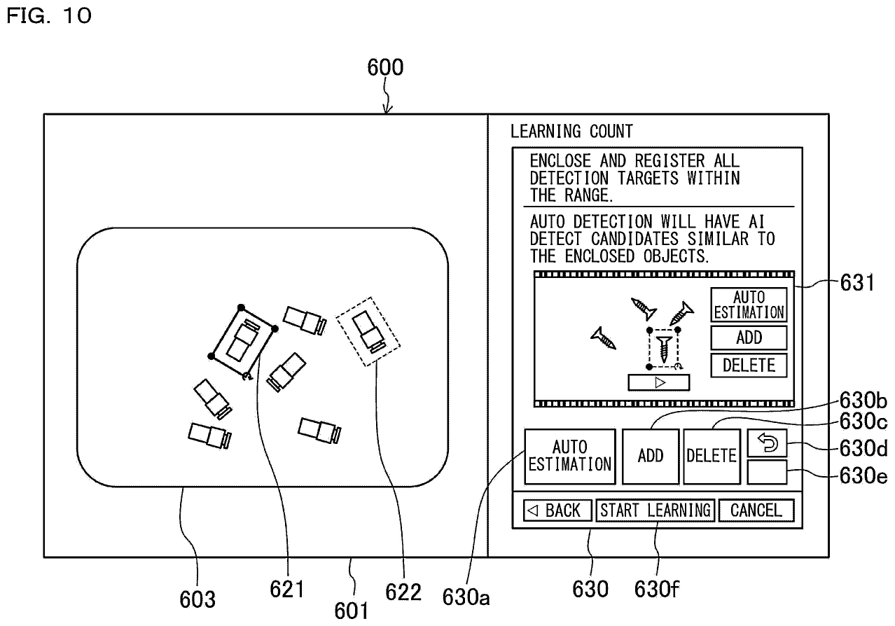

Then, the process proceeds to step SC3 of the flowchart shown in FIG. 6. In step SC3, based on the first setting area specified in step SC2, a setting area determination flow is initiated, in which the setting area is determined by the learning data setting unit 310 and the user, and proceeds to step SC4. In step SC4, input of an automatic estimation instruction by the user is accepted. Specifically, the learning data setting unit 310 displays a setting screen 600, as shown in FIG. 10, on the display device 4. The setting screen 600 shown in FIG. 10 includes a setting area determination window 630.

The setting area determination window 630 is provided with an automatic estimation button 630a, an add button 630b, a delete button 630c, an undo button 630d, a bulk delete button 630e, and a learning start button 630f. The automatic estimation button 630a is a button for instructing the automatic estimation of candidate areas. As shown in the setting image display area 601 in FIG. 10, when the learning data setting unit 310 displays information indicating the position of the first setting area (designated box 621) superimposed on the setting image I3 and receives user operation of the automatic estimation button 630a, the candidate area estimation unit 312 estimates candidate areas such that areas other than the first setting area are treated as candidate areas. More specifically, the candidate area estimation unit 312 executes a pre-trained model to identify areas from the setting image I3 that have similar features to the first setting area specified in step SC2, and estimates those areas as candidate areas. This is the processing of step SC5 shown in FIG. 6. The user operation of the automatic estimation button 630a is an instruction to execute the estimation of learning candidate areas.

In step SC6, the setting image display unit 311 superimposes a candidate box 622, which surrounds the area automatically estimated as a candidate region, onto the setting image I3 in the setting image display area 601. The line type of the candidate box 622 is different from the line type of the designated box 621 (solid line), specifically being a dashed line. The estimation result by the candidate region estimation unit 312 may differ from the user's intention, and in this case, the user identifies the estimated candidate region and performs an editing operation. Therefore, the candidate box 622 is displayed in a manner that distinguishes the candidate region estimated in step SC5 from the setting region designated in step SC2. It is sufficient to distinguish between the designated box 621 and the candidate box 622, so, for example, in addition to changing the line type between the designated box 621 and the candidate box 622, it may also be a manner of displaying by changing the color.

After the second learning candidate region is automatically estimated, when the user operates the auto estimation button 630a, the candidate region estimation unit 312 estimates the learning candidate region such that the area other than the first learning candidate region and the second learning candidate region becomes the third learning candidate region. For example, after estimating the second learning candidate region, the candidate region estimation unit 312 estimates the position corresponding to the class feature quantity similar to the reference class feature quantity within a certain range based on the feature quantity for each pixel as the third learning candidate region. At this time, the candidate region estimation unit 312 can estimate the third learning candidate region using the class feature quantity of the second learning candidate region as the reference class feature quantity.

In step SC7 shown in FIG. 6, it is determined whether or not a deletion instruction for the estimated area has been made by the user. The user looks at the display from step SC6 and judges whether all the candidate areas estimated by the candidate area estimation unit 312 are as intended by the user. If the position, size, or angle of the candidate area differs from the user's intention, the user performs an editing operation on the candidate box 622, and if there are unnecessary estimated areas, the user instructs the deletion of the estimated area by deleting the candidate box 622 indicating the corresponding estimated area. The learning data setting unit 310 determines whether or not this deletion instruction has been accepted. If there is a deletion instruction, the process proceeds to step SC8, and if there is no deletion instruction, the process proceeds to step SC9.

In step SC8, the learning data setting unit 310 executes a process to delete candidate regions. The learning data setting unit 310 deletes the candidate box 622 and retains the candidate region that received the deletion instruction as the deletion setting position. The deletion setting position is information that will be read in the automatic estimation performed later based on the re-estimation instruction described later, and the candidate region estimation unit 312 estimates the candidate region so as not to include the same position as the deletion setting position. In other words, the learning data setting unit 310 executes a process to exclude the same position as the deleted candidate region from the candidate regions as the results of subsequent automatic estimation.

In step SC9, it is determined whether a re-estimation instruction has been made. The user looks at the display from step SC6 and judges whether there are areas that should be estimated as candidate regions in the setting image I3 and where the candidate box 622 is not displayed. In other words, the user determines whether there are areas that should be added as setting regions in the setting image I3. When it is judged that there are areas to be added, the user can instruct automatic estimation again, and the learning data setting unit 310 determines whether the instruction has been accepted. If there is a re-estimation instruction, the process proceeds to step SC5 to perform automatic estimation again, and if there is no re-estimation instruction, the process proceeds to step SC10, where the candidate regions at this point are determined as setting regions, and the setting region determination flow ends.

This describes the processing of Step SC5 that is executed when it is determined that there is a re-estimation instruction in Step SC9. For convenience of explanation, the candidate region estimated by the first processing of Step SC5 is referred to as the first candidate region, and the candidate box 622 indicating the first candidate region is referred to as the first candidate box 622a. The candidate region estimated by the second processing of Step SC5 executed due to the re-estimation instruction is referred to as the second candidate region, and the second candidate box 622 indicating the second candidate region is referred to as 622b.

First, when the judgment of step SC9 is executed, the setting screen display unit 311 is in a state of displaying the output from step SC6. In other words, it accepts a re-estimation instruction while displaying a first candidate box 622a that indicates the position of the first candidate region estimated by the candidate region estimation unit 312 superimposed on the setting image I3. When the re-estimation instruction is accepted, the setting screen display unit 311 may change the aspect of the first candidate box 622a. Since the user can perform editing operations on the first candidate box 622a before instructing a new automatic estimation, it can be considered that the position of the first candidate region indicated by the first candidate box 622 is confirmed by the user by accepting the re-estimation instruction. If the aspect of the changed first candidate box 622a is the same as or similar to that of the designated box 621, the change in the aspect of the first box 622a makes it easier for the user to distinguish between the area designated or confirmed by the user and the candidate region estimated by the candidate region estimation unit 312 that has not been confirmed by the user. Furthermore, by differentiating the aspect of the changed first box 622a from that of the designated box 621, it becomes easier for the user to distinguish whether it is a candidate region estimated by the candidate region estimation unit 312 or not.

Furthermore, it is preferable to prompt editing operations for the first candidate box 622a before accepting the re-estimation instruction. The first candidate region estimated by the candidate region estimation unit 312 may be incorrect, and the user can correct the position and size of the candidate region by moving the first candidate box 622a or changing the shape, size, and angle of the first box 622a by operating a mouse or the like. The fact that the estimation of the second candidate region is instructed afterward indicates that the first candidate region is in a correct state, and by reflecting this correction content and executing the estimation of the second candidate region, the accuracy of the estimation result of the second candidate region can be improved.

When step SC5 is executed based on the judgment of step SC9, the candidate region estimation unit 312 estimates the second candidate region so that the area other than the first setting region and the first candidate region becomes the second candidate region. At this time, if the processing of step SC5 by the candidate region estimation unit 312 is the same processing as the first processing of step SC5, that is, the automatic estimation that estimates the first candidate region, the area other than the first candidate region is not estimated as a candidate region. Therefore, the processing of the second step SC5 is different from the first step SC5.

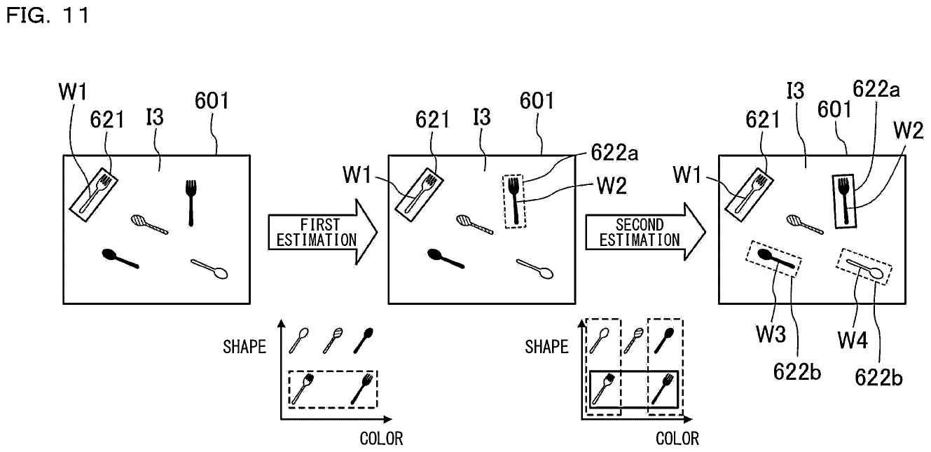

FIG. 11 is a conceptual diagram explaining the difference between the processing of the first step SC5, that is, the estimation of the first candidate region, and the processing of the second step SC5, that is, the estimation of the second candidate region.

This section describes the estimation of the first candidate region. The candidate region estimation unit 312 estimates a region having the target object W1 specified by the designated box 621 as the first setting region, using the feature quantity of that region as the reference feature quantity, and estimates a region having feature quantities similar to the reference feature quantity as the first candidate region. Assuming that the feature quantity is determined by the two axes of the shape and color of the object, in the estimation of the first candidate region, a region containing the object W2 having a shape similar to that of the object is identified as a region from which similar feature quantities to the first setting region can be obtained. In this way, the candidate region estimation unit 312 estimates the region containing the object W2 as the first candidate region and displays the first candidate box 622a.

The estimation of the second candidate region will be explained. In this embodiment, the candidate region estimation unit 312 estimates a region different from the first setting region and the first candidate region as the second candidate region by combining two methods. First, the candidate region estimation unit 312 identifies a region having features similar to the reference feature quantity by expanding the range of similarity more than when estimating the first candidate region, while using the features of the first setting region, that is, the region where the target object W1 specified by the designated box 621 is located, as the reference feature quantity, from the setting image I3. FIG. 11 shows a state in which a region containing an object W4 of a color similar to that of the target object W1 is identified as a region where features similar to those of the first setting region are obtained as a result of expanding the range of similarity. Next, the candidate region estimation unit 312 identifies a region having features similar to the reference feature quantity from the setting image I3, using the features of the candidate region estimated in the processing of the first step SC5, that is, the first candidate box indicated by the first candidate box 622a, as the reference feature quantity. In the estimation of the second candidate region in this embodiment, it is determined that the features are similar when the colors of the objects are similar, so a region containing an object W3 of a color similar to that of the object W2 in the first candidate region is identified as a region where features similar to those of the first candidate region are obtained. In this way, a region different from the first setting region and the first candidate region is estimated as the second candidate region. In this embodiment, the second candidate region is estimated using the features of the first candidate region as the reference feature quantity while expanding the range of similarity, but the second candidate region may be estimated by either method or by another method. Also, in this embodiment, when estimating the second candidate region using the features of the first candidate region as the reference feature quantity, it is estimated in an expanded range of similarity compared to when estimating the first candidate region, but it may also be estimated in a similar range to that of the first candidate region estimation. For example, it may be a configuration in which a region containing an object having a shape similar to that of the object W2 located in the first candidate region is estimated as the second candidate region.

After the processing of the second step SC5, as with the processing after the first step SC5, the estimation result by the candidate region estimation unit 312 is displayed as step SC5. The user can view the display by step SC6 and re-evaluate whether there are regions that should be added as candidate areas in the setting image I3, and can make estimation instructions repeatedly until it is determined that there are no regions to be added. In this way, the user can obtain the estimation result from the candidate region estimation unit 312, which has increased the candidate regions, just by making the estimation instructions.

Proceeding to step SC10, when the setting area determination flow is completed, the learning data generation unit 310b generates learning data D1 based on the image data of the setting image I3, the setting area set as label information, and the candidate area corresponding to the candidate box 622 that was displayed when the setting area determination flow was completed. The candidate area corresponding to the candidate box 622 that was displayed when the setting area determination flow was completed is considered to be confirmed by the user. That is, at the point of step SC10, the area specified by the designated box 621 and the candidate box 622 displayed superimposed on the setting image I3 is treated as the setting area specified by the user in the label information setting unit 310c, and based on the setting area and the image data of the setting image I3, the learning data generation unit 310b generates the learning data D1. More specifically, based on the setting area, the feature quantity F2 indicating the object is identified from the setting image I3, thereby updating the judgment unit.

In the flowchart of FIG. 6, as steps related to instructions from the user, there are a step SC7 for determining the presence or absence of a deletion instruction and a step SC9 for determining the presence or absence of a re-estimation instruction; however, after step SC6, the user can provide various instructions. This will be explained using FIG. 10.

The automatic estimation button 630a is a button for instructing automatic estimation of candidate regions, as mentioned above. The user can issue a re-estimation instruction by operating the automatic estimation button 630a.

The add button 630b is a button that the user operates when manually adding a setting area. As shown in FIG. 10, when the first setting area is specified and the designated box 621 is displayed, and the first candidate area is estimated and the first candidate box 622a is displayed, if the user wants to add a second setting area, the learning data setting unit 310 displays a designated box 621, different from the designated box 621 corresponding to the first setting area, at any position in the setting image display area 601 when it receives the user's operation of the add button 630b. The user can move the displayed designated box 621 by operating a mouse or the like, or change the shape, size, and angle of the designated box 621 to arrange it to enclose the second setting area. This allows the second setting area to be added manually.

The delete button 630c is a button that the user operates when deleting the selected candidate box 622. The learning data setting unit 310 detects that the delete button 630c has been operated by the user when the candidate box 622 is selected, and determines that there is a deletion instruction for the candidate region in step SC7. Then, the learning data setting unit 310 deletes the candidate box 622 and executes the process of removing the area surrounded by the deleted candidate box 622 from the candidate region as the estimation result of subsequent automatic estimation. When multiple candidate regions are estimated in step SC5 and multiple candidate boxes 622 are displayed in step SC6, the deletion of the candidate box 622 can be performed as many times as needed.

The undo button 630d is a button that is operated to undo the operations performed in the setting area determination window 630. The learning data setting unit 310 accepts the operation of the undo button 630d by the user and returns to the state before the last operation by canceling the last operation. For example, if the undo button 630d is operated immediately after the designated box 621 is added, the designated box 621 is erased. Also, if the undo button 630d is operated immediately after the candidate box 622 is deleted, the candidate box 622 is displayed. Furthermore, if the undo button 630d is operated immediately after the editing operation of the candidate box 622 is performed, it returns to the state just before that editing operation.

The bulk delete button 630e is a button for deleting all candidate boxes 622 shown in FIG. 10 in bulk. The learning data setting unit 310 accepts user operations on the bulk delete button 630e, deletes all candidate boxes 622, and executes the process of removing each candidate region surrounded by each candidate box 622 from the candidate regions.

The process of estimating the candidate region is not particularly limited, but can be performed as follows. For example, the candidate region estimation unit 312 acquires the image data of the setting image I3 and the information indicating the position of the first setting region that is already superimposed on the setting image display area 601. The information indicating the position of the first setting region may be one specified manually by the user or one estimated automatically.

Next, the candidate region estimation unit 312 estimates the candidate region. At this time, the candidate region can be estimated by a predetermined method, and when multiple candidate regions are estimated, a candidate box 622 indicating the multiple candidate regions is superimposed on the same setting image I3.

Furthermore, the candidate region estimation unit 312 calculates the feature quantity corresponding to the information indicating the position of the first setting candidate region that is already superimposed and the feature quantities of each region obtained from the image data of the setting image I3. Thereafter, the candidate region estimation unit 312 calculates the similarity of the feature quantities of each region obtained from the image data of the setting image I3 based on any of the feature quantities corresponding to the information indicating the position of the first setting region that is already superimposed. Subsequently, the candidate region estimation unit 312 determines the candidate region to be presented to the user based on the calculated similarity. At this time, if there is a record of deletion instructions by the user, the candidate region is determined so as not to include the location of the deletion instruction in the candidate regions to be presented to the user.

Furthermore, the candidate region estimation unit 312 can retain predetermined reference feature quantities. The reference feature quantities are features when a general object is present, which are determined by the business operator providing the image inspection device S, not by the user, and are set at the time of shipment. The candidate region estimation unit 312 identifies coordinates that are similar on a point-by-point basis based on the reference feature quantities and defines the area containing those coordinates as the learning candidate region.

In this process, it is assumed that the predetermined reference feature quantity is point-based; however, the reference feature quantity, which takes into account the size of the image area of general objects and the tilt angle, is retained, and the image area corresponding to the feature quantity with high similarity to the setting image data may also be used as a learning candidate region. In this case, it is possible to estimate the learning candidate region while suppressing the increase in the processing load of the comparison between the reference feature quantity and the setting image data, taking into account the size and angle of the image area.

Moreover, it is also possible to retain features related to size and tilt angle in advance, and use the identified coordinate group as the first stage candidates, and further narrow down the learning candidate region based on the similarity between the features calculated for each coordinate and the size and tilt angle features. At this time, the features calculated for each coordinate indicate the size of the image area when the coordinate is included in the image area of a general object, and the tilt angle of the image area.

Moreover, the first setting area is narrowed down based on the information indicating the position of the first setting area that is already superimposed. The candidate region estimation unit 312 extracts features from the information indicating the position of the first setting area that is already superimposed, identifies coordinates that are similar on a point-by-point basis, and defines the area including those coordinates as the candidate region. By performing comparisons on a point-by-point basis, the load of the comparison process is reduced, and since the features of the setting image data are compared with the instructed data (the information indicating the position of the first setting area that is already superimposed), the risk of estimating areas similar to the object to be detected as candidate regions and the risk of estimating areas containing objects other than the object to be detected as candidate regions are reduced.

At this time, it is also possible to compare based on the size feature and angle feature for the corresponding coordinates. In other words, it is possible to narrow down the candidate regions based on the size and angle of the information indicating the position of the first setting region that is already superimposed. At this time, the values indicating the size and angle of the information indicating the position of the first setting region that is already superimposed may be used for narrowing down, or features indicating these may be extracted, and the similarity with the features calculated for each coordinate of the coordinate group in a similar manner may be used for narrowing down.

As shown in FIG. 10, the setting area determination window 630 is provided with an operation explanation section 631, where the method of operation is displayed in a video.

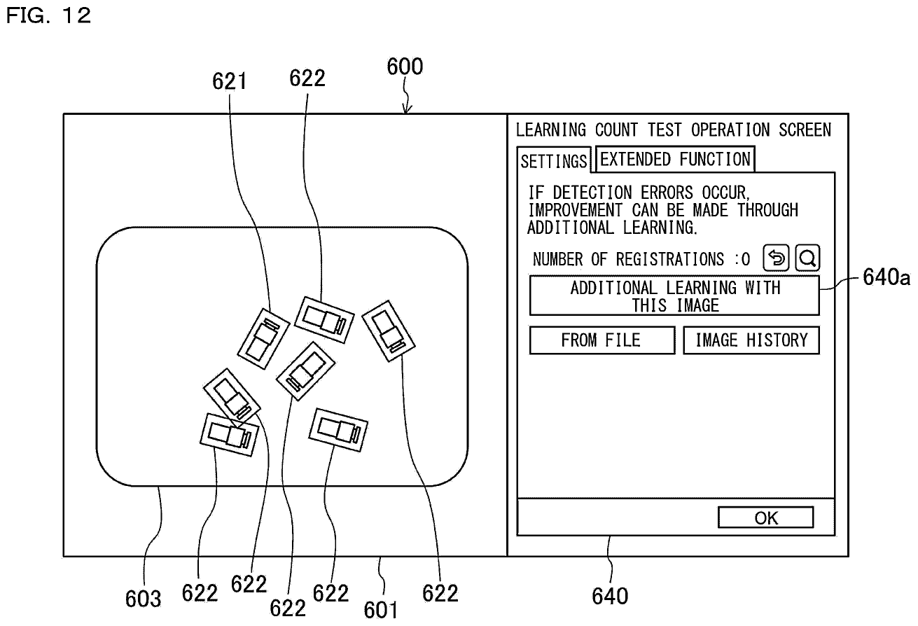

The judgment unit update part 315 detects that the learning start button 630f has been operated, and updates the pre-trained model based on the feature quantity F2, which is the feature quantity corresponding to the setting area, based on the generated learning data D1. An example of the image used during learning execution is shown in FIG. 12. In FIG. 12, a test operation window 640 is displayed, and it is possible to set whether to update the pre-trained model based on the setting image I3 displayed in the setting image display area 601. The test operation window 640 is provided with an additional learning button 640a that allows a decision on whether to perform additional learning with this setting image. In this example, a specified box 621 and six candidate boxes 622 are displayed, totaling seven setting areas.

During learning, the classifier update unit 315 classifies the setting area into the class of the target object and classifies the area outside the setting area into the class of the background, thereby training the pre-trained model. Furthermore, the classifier update unit 315 can learn the boundary that separates the class of the target object from the class of the background. In this case, the pre-trained model can detect the target object in the image of the inference image data based on the feature quantity per pixel and the boundary.

### During Operation of the Image Inspection Device

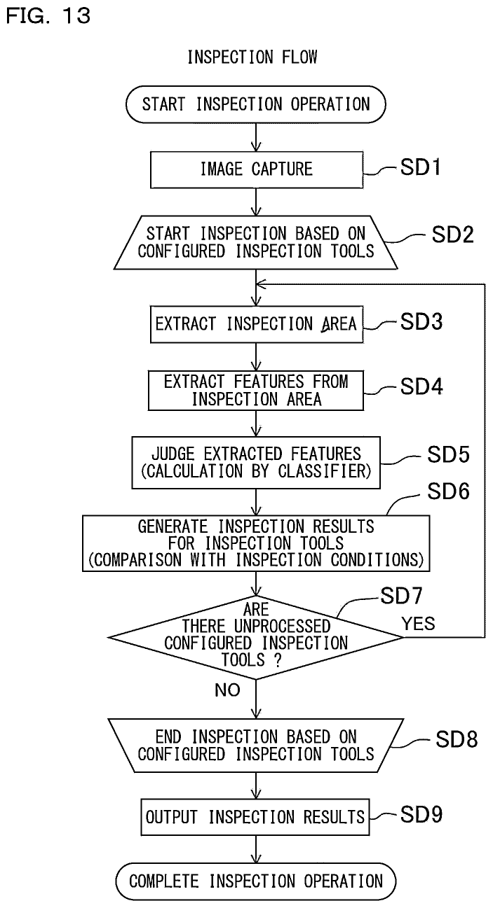

FIG. 13 is a flowchart showing the procedure during operation of the image inspection device S. The image inspection device S can switch between a setting mode that performs settings as shown in FIGS. 4 to 6 and an operation mode shown in FIG. 13, but this mode switching does not have to be clear, and for example, it is also possible to temporarily switch to the setting mode to change settings while operating in the operation mode, and then return to the operation mode for continuous operation.

In step SD1 after the start, the imaging unit 1 captures the work W and acquires the image data of the work W. In step SD2, inspection based on the configured inspection tool is started for the image of the work W acquired in step SD1. First, in step SD3, based on the inspection range set in the inspection window setting unit, the range of the image of the work W acquired in step SD1 that is subject to inspection is cut out.

In step SD4, the feature extraction unit extracts the features of the inspection area cut out in step SD3. In step SD5, the features extracted in step SD4 are judged by the classifier. As mentioned above, in steps SD4 and SD5, the features change depending on the inspection tool or the classifier used.

In step SD6, the inspection results are created by the inspection tool, and a comparison with the inspection conditions is made at this time. In step SD7, the presence or absence of unprocessed configured inspection tools is determined. If there are unprocessed configured inspection tools, proceed to step SD3, while if there are no unprocessed configured inspection tools, proceed to step SD8. In step SD8, the inspection based on the configured inspection tools is concluded.

In step SD9, the inspection result output unit outputs the inspection result. When there is one configured inspection tool, the inspection result related to that configured inspection tool is output as is, but when combining multiple configured inspection tools, further inspection results are generated and output based on the inspection results of each inspection tool.

### Learning Count Function

The image inspection device S can update the pre-trained model so that the learning data generation unit 310b classifies candidate regions into classes of target objects based on learning data, even when multiple candidate regions exist in the image of the input image data. In other words, it is particularly effective when multiple objects are present within the imaging field of view, and it is a suitable configuration for the learning count tool.

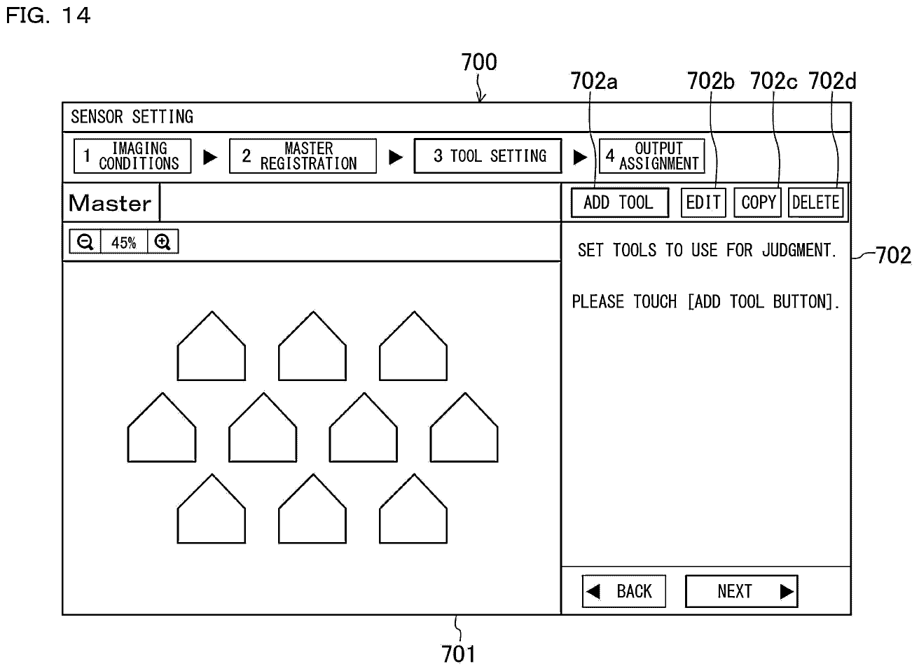

The control unit 21 generates and displays a tool setting screen 700 on the display device 4 when a tool setting operation is performed by the user, as shown in FIG. 14. The tool setting screen 700 is provided with an image display area 701 where a work image captured by the imaging unit 1 is displayed, and a setting area 702 where various setting operations can be performed. The setting area 702 is equipped with a tool addition button 702a for adding tools used for judgment, an edit button 702b for editing tools, a copy button 702c for copying tools, and a delete button 702d for deleting tools. Each button 702a, 702b, 702c, and 702d is composed of an image displayed on the display device 4, allowing touch operations using the touch panel 4a; however, it may also be composed of physically operable buttons. The same applies to the buttons below.

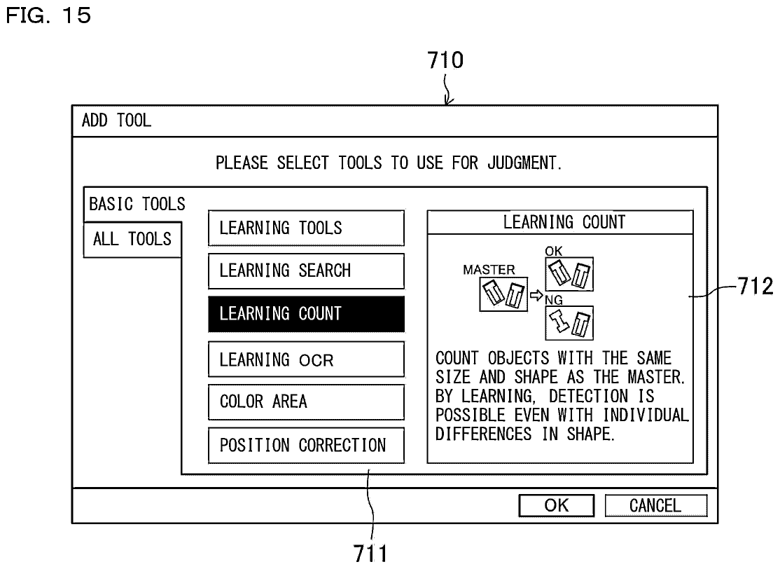

The control unit 21 detects that the tool addition button 702a has been operated, and generates and displays the tool selection window 710 shown in FIG. 15 on the display device 4. The tool selection window 710 is provided with a tool display area 711 that allows selection of basic tools and an explanation display area 712 that displays the description of the selected tool. The tool display area 711 displays buttons corresponding to multiple tools such as learning tool, learning search, learning count, learning OCR (optical character recognition), color area, position correction, etc., and is capable of accepting selection operations by the user. The description regarding the tool selected in the tool display area 711 is displayed in the explanation display area 712. The explanation regarding the tool includes the function explanation of the tool, operation explanation during tool use, etc. In this example, the case where the learning count tool is selected is shown.

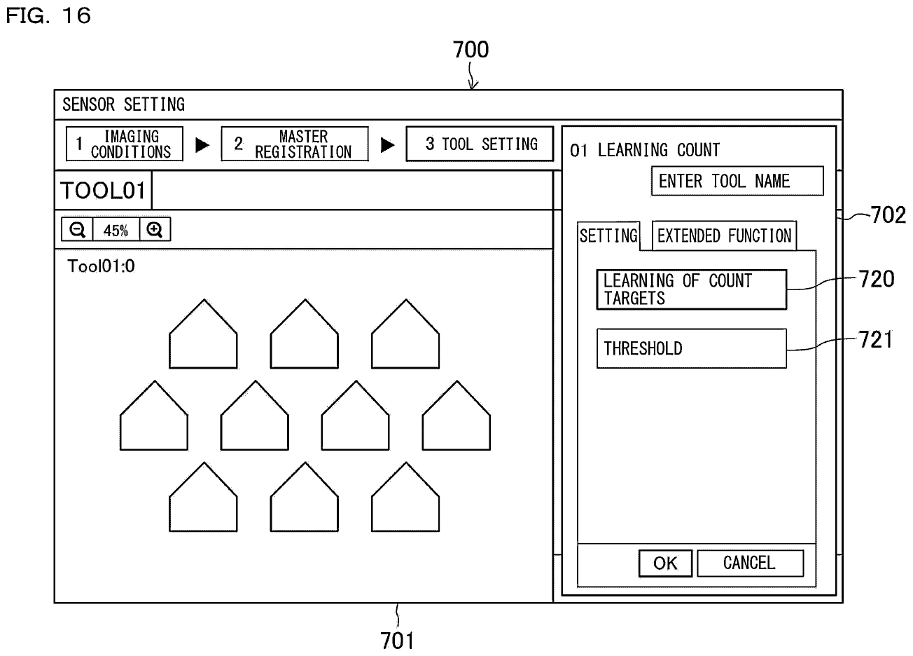

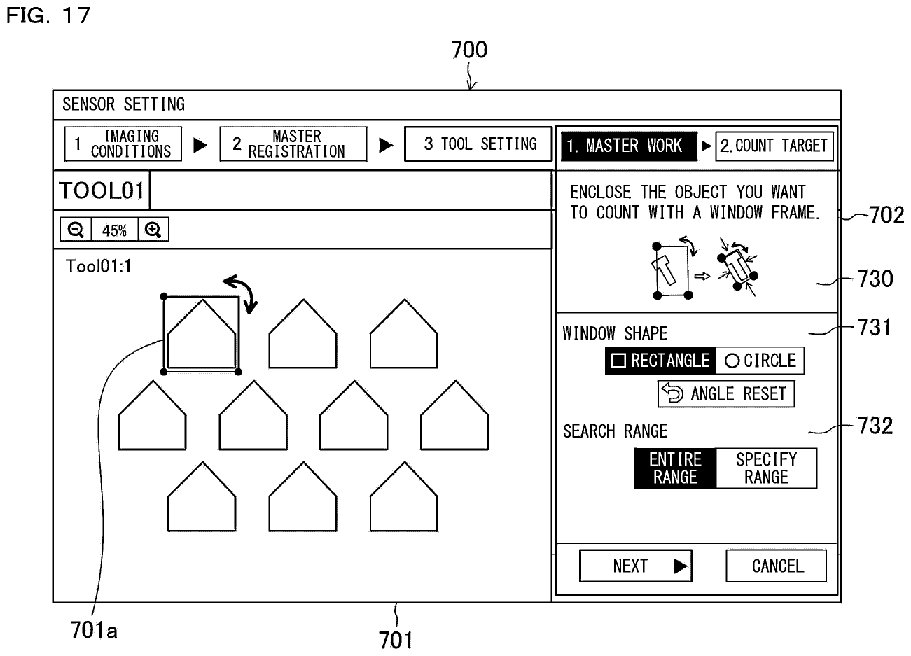

The control unit 21 detects that the learning count tool has been selected, and as shown in FIG. 16, displays a learning setting button 720 for performing detailed settings of the tool and a threshold setting button 721 for setting the threshold in the setting area 702. When the control unit 21 detects that the learning setting button 720 has been operated, it generates a box setting area 730 for setting a first box 701a that surrounds the reference master work, and displays it on the display device 4 as shown in FIG. 17. The box setting area 730 is provided with a shape selection area 731 for selecting whether to make the shape of the first box 701a rectangular or circular, and a range setting area 732 for selecting whether to set the search range to the entire range or to a specified range. The first box 701a can be formed on the image displayed in the image display area 701, for example, by the user performing a touch operation. For example, the first box 701a can be formed by dragging from the upper left to the lower right of the area to be enclosed. The size and aspect ratio of the first box 701a can be freely changed. When the first box 701a is formed, the control unit 21 identifies the image area surrounded by the first box 701a and accepts the designation of the image area.

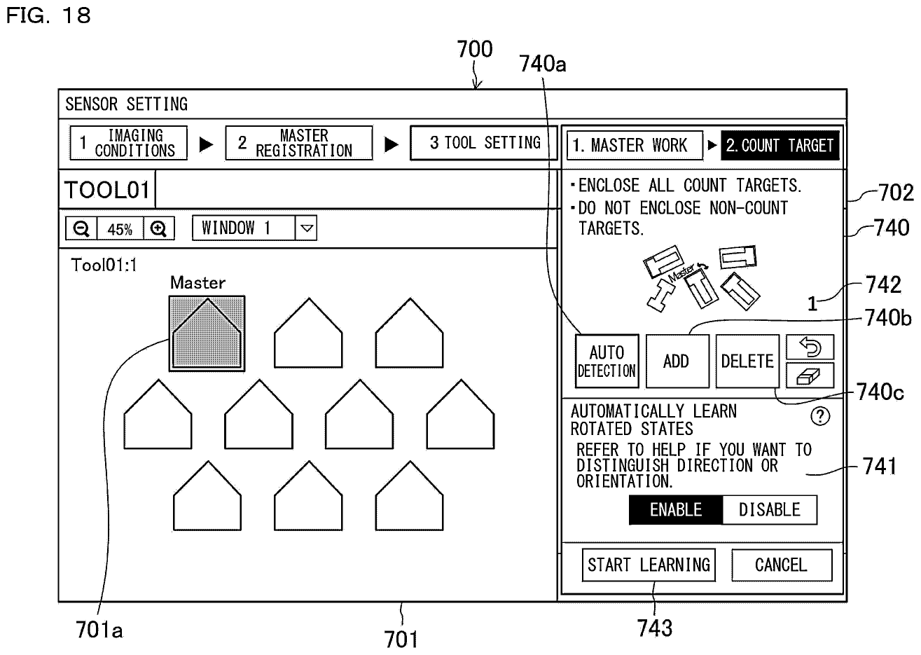

When the designation of the image area by the first box 701a is completed, as shown in FIG. 18, the control unit 21 displays the designated image area as a master and generates a count target setting area 740 for setting the count target, which is displayed on the display device 4. The count target setting area 740 is provided with an auto detection button 740a for automatically detecting the count target, an add button 740b for adding count targets, and a delete button 740c for deleting count targets. Furthermore, the count target setting area 740 includes a selection area 741 for selecting whether to automatically learn the state in which the workpiece is rotated, a count number display area 742 where the count number is displayed, and a learning start button 743. The process of automatically learning the state in which the workpiece is rotated is called rotational auto-learning, and when performing rotational auto-learning, the user should select ‘enabled’ in the selection area 741, and if not performing rotational auto-learning, the user should select ‘disabled’ in the selection area 741. Details about rotational auto-learning will be described later. In addition, in FIG. 18, since only the master is counted by the count tool, ‘1’ is displayed in the count number display area 742. This allows the user to easily understand the number annotated.

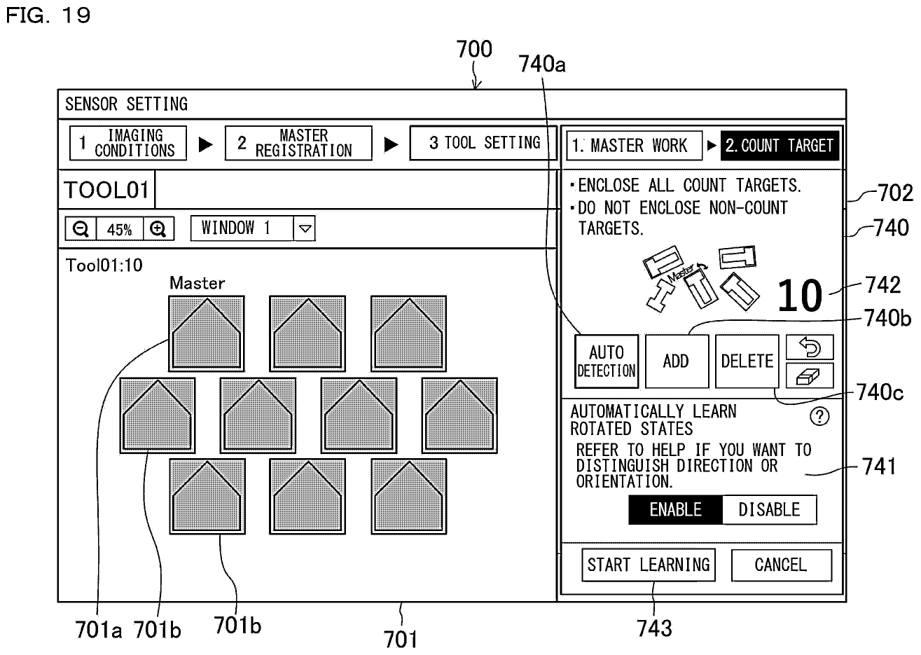

The control unit 21 detects that the automatic detection button 740a has been operated, and automatically detects whether or not a work identical or similar to the master work is included in the image displayed in the image display area 701. As shown in FIG. 19, when a work identical or similar to the master work is detected, the control unit 21 superimposes a second box 701b surrounding that work. The example shown in FIG. 19 indicates a case where nine works other than the master work are detected, and therefore, nine second boxes 701b are displayed. In addition, since a total of ten works, including the master work, are counted,

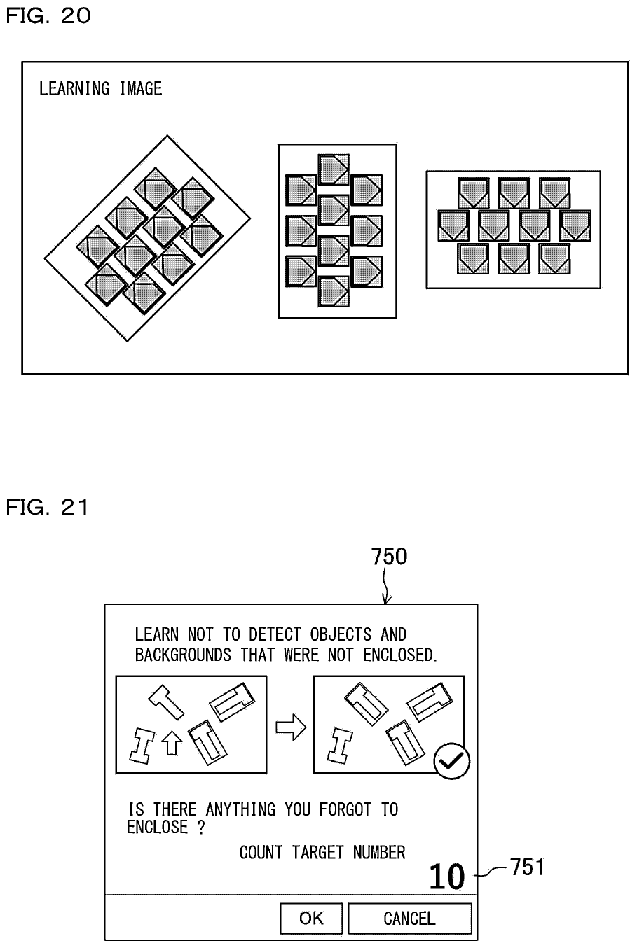

FIG. 20 is a diagram showing an example of an image used in rotational auto-learning. As shown in this diagram,
the control unit 21 automatically generates multiple rotated images, and the generated images can be used as learning images.
   This allows for automatic detection of the workpiece even when images of the workpiece with changed posture are input during the operation of the image inspection device S.

The control unit 21 generates and displays a caution display window 750 on the display device 4 before executing the learning, as shown in FIG. 21. The caution display window 750 is a screen for the final confirmation just before learning, and by displaying this screen, it is possible to prevent a decrease in learning accuracy when learning considering unconfigured objects.

The warning display window 750 displays messages and illustrations to confirm whether there are any unset items in the tool or any uncircled work, for example. This is because the work that was not circled is registered as defective work. It is also possible to issue a warning when forgetting to circle something that is clearly similar to the master work. The control unit 21 calculates the similarity with items that are already circled during automatic detection and determines whether to circle the uncircled items based on the calculated similarity. A warning can be issued when items with high similarity remain uncircled by the box. In addition, the warning display window 750 also displays the count number display area 751.

The user checks the caution display window 750 in FIG. 21, and if there are no problems, operates the learning start button 743 shown in FIG. 18. When the control unit 21 detects that the learning start button 743 has been operated, it executes additional learning of the model.

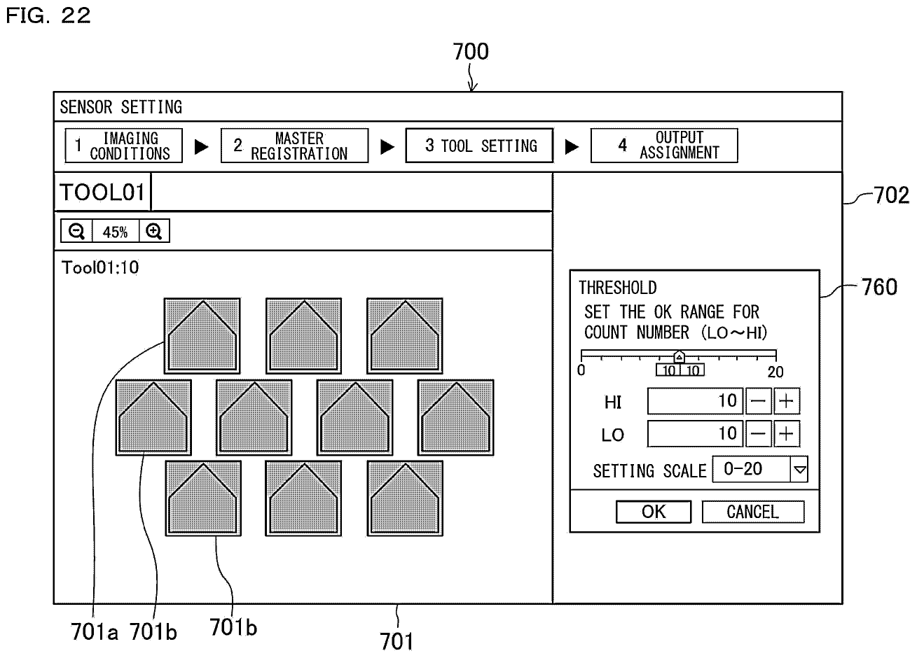

The control unit 21 can generate a setting window 760 (shown in FIG. 22) for setting the upper and lower limits of the count number and display it on the display device 4. The upper and lower limits of the count number are automatically set according to the number of master images. The setting window 760 allows the range of the count number to be set, and the upper limit (HI) and lower limit (LO) of the count number can be individually changed.

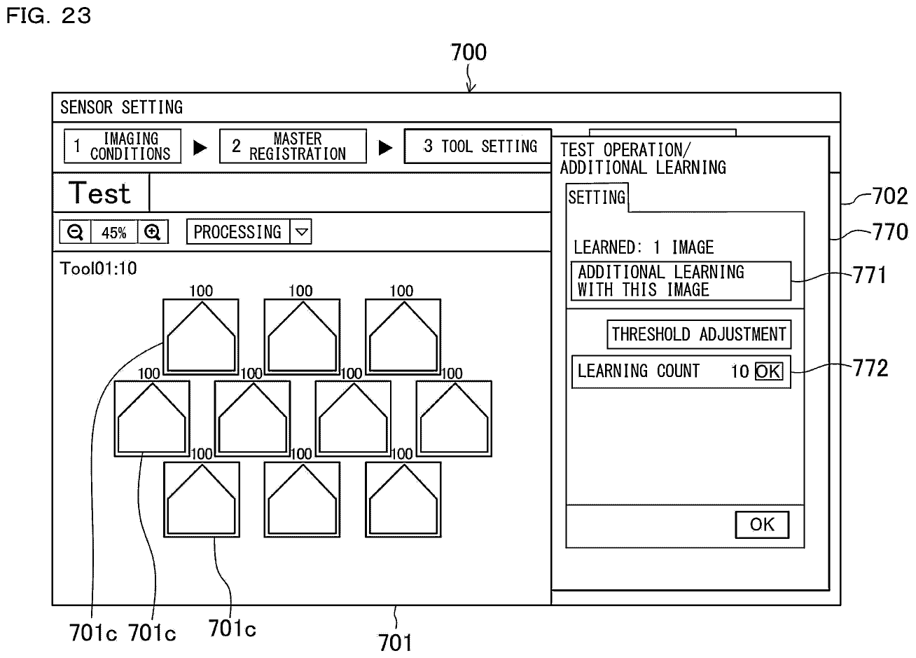

The control unit 21, upon receiving a test operation instruction from the user, executes a process in which the model after additional learning detects the target object in the image. FIG. 23 is a test screen generated by the control unit 21 during the test operation and displayed on the display device 4, where the image input during the test operation is displayed in the image display area 701. A third box 701c that surrounds the work detected by the model is superimposed on the image.

The control unit 21 generates and displays the test operation/additional learning window 770 on the display device 4. The test operation/additional learning window 770 is provided with an additional learning button 771 for additional learning of the image displayed in the image display area 701, and a learning count display area 772. The learning count display area 772 displays the number of works detected by the model, that is, the count number. In this example, since 10 works have been detected, “10” is displayed.

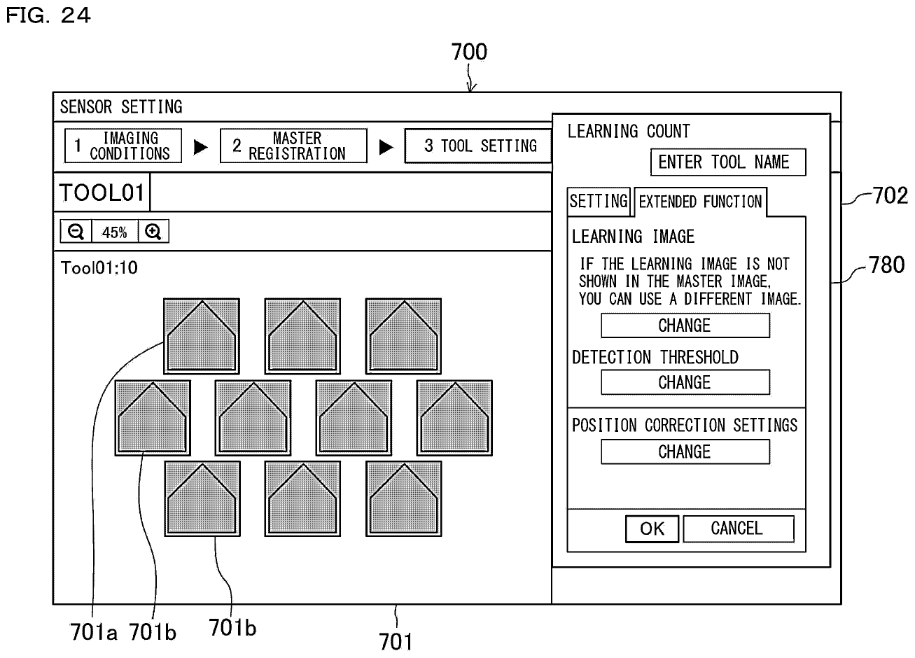

The control unit 21 generates and displays the extended function setting window 780 (shown in FIG. 24) on the display device 4. In the setting window 780, it is possible to accept the change of the learning image to another image, as in the case where the count target is not included in the master image, as well as changes to the detection threshold for the count target and changes to the position correction settings.

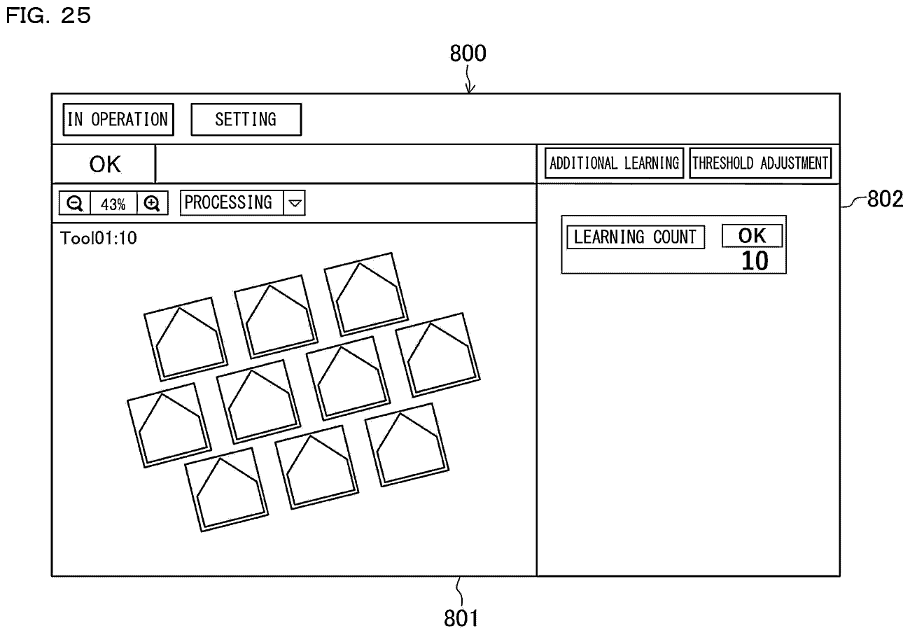

FIG. 25 shows the operation screen 800 displayed during the operation of the image inspection device S, and the control unit 21 generates the operation screen 800 and displays it on the display device 4. The operation screen 800 is provided with an image display area 801 where the image input during operation is displayed, and a result display area 802. The result display area 802 is configured to display the judgment results of each tool, and in the example shown in FIG. 25, the judgment result by the learning count tool is displayed along with the count number. Furthermore, in the image input during operation, the workpiece is tilted, but since the model is being trained using learning images as shown in FIG. 20, the tilted workpiece can also be detected stably.

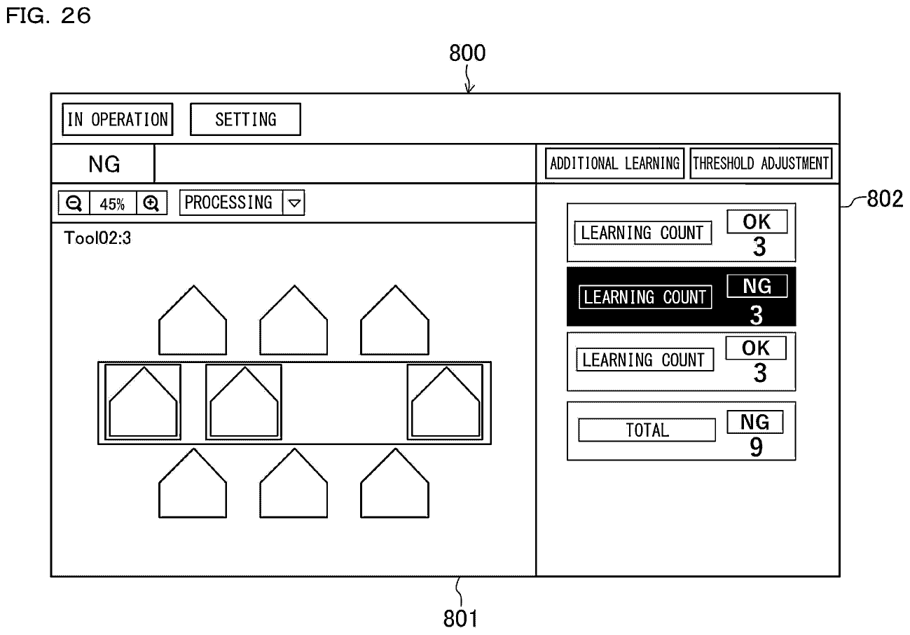

FIG. 26 is a diagram showing an example of the judgment result displayed by the total tool. The total tool counts for each location where the tool is set and uses both the number for each location and the total to make the final judgment. In FIG. 26, learning count tools are set for the upper, middle, and lower sections, and it shows a case where only three workpieces were detected instead of the four that should have been detected by the learning count tool set in the middle section. Thus, in the result display area 802, good and defective are displayed for each tool, allowing the user to easily confirm which tool at which location has a defect. In other words, since multiple tools can be set within the imaging field and the setting of the total tool that sums the count of those tools is also possible, it is possible to check which part does not have the target object based on the results for each tool setting position. In addition to the tool setting methods such as upper, middle, and lower sections, tool setting methods such as left, center, and right are also possible.

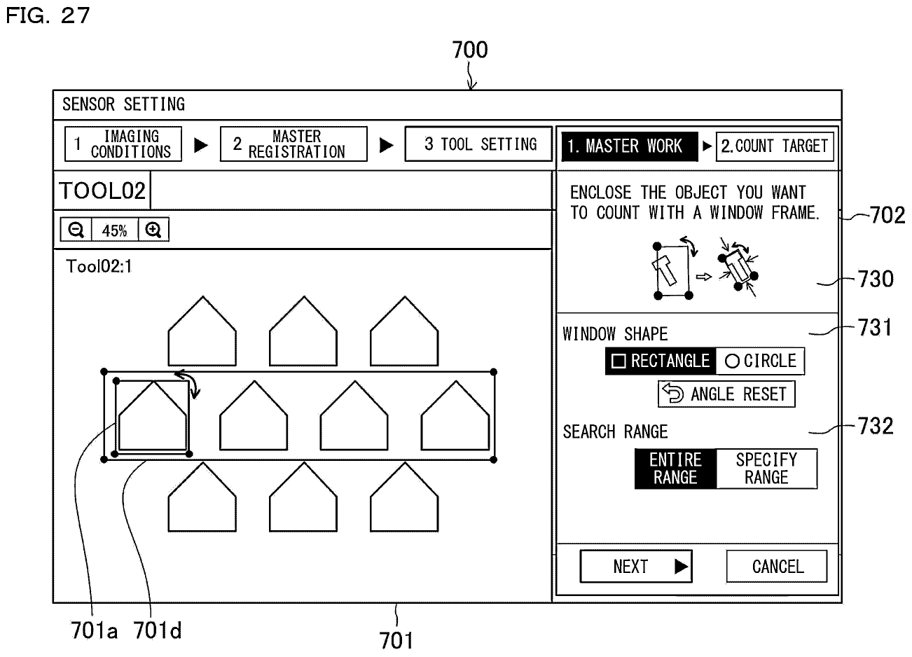

FIG. 27 shows a case where a learning count tool is set in the middle section. As shown in this figure, the user generates the fourth box 701d to enclose the four works in the middle section as the search range. The fourth box 701d can be generated in the same way as the first box 701a.

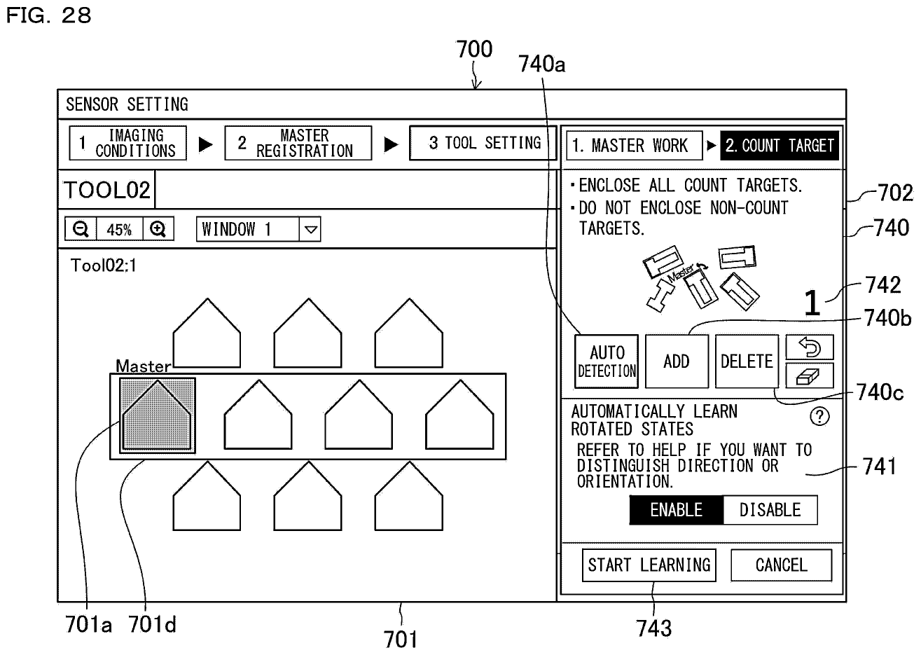

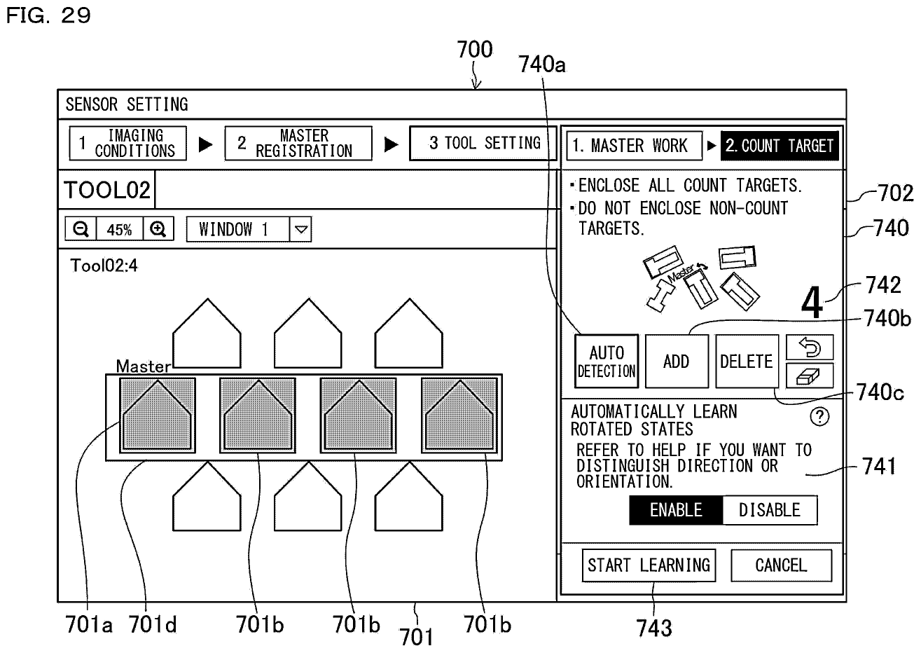

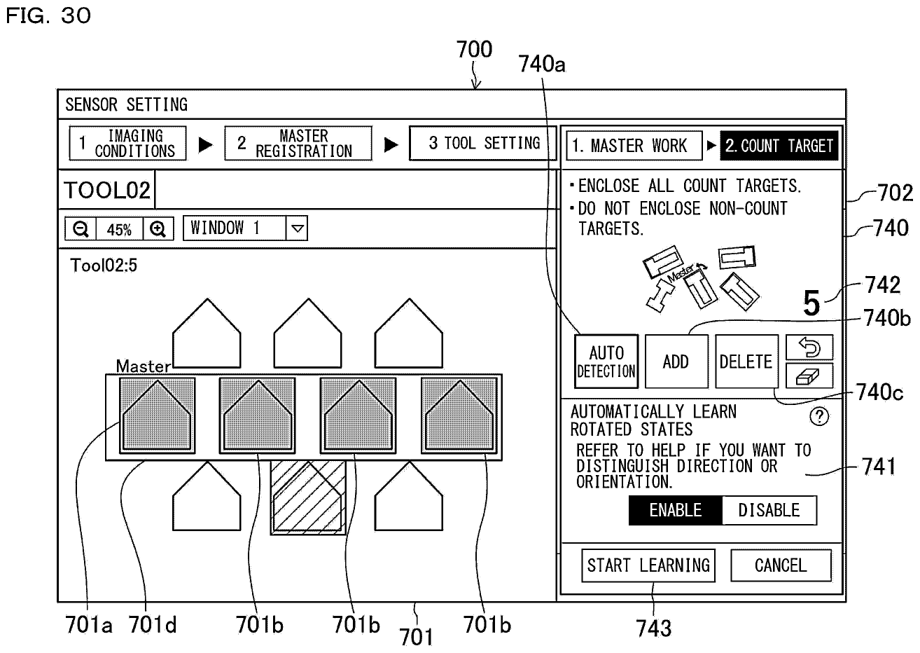

In the fourth box 701d, the work enclosed by the first box 701a becomes the master work, and as shown in FIG. 28, the control unit 21 displays the specified image area as the master. Then, as shown in FIG. 29, count targets are automatically detected within the fourth box 701d. For example, as shown in FIG. 30, if something annotated later goes outside the search range after changing the search range, the control unit 21 displays a warning with a diagonal line. The warning display is not limited to diagonal lines; it may also be a display using colors such as red, or a display using characters or symbols. In other words, when annotations are executed outside the tool, it can notify the user, so that when the objects to be detected change for each tool, it can prevent inappropriate items from being set as learning data.

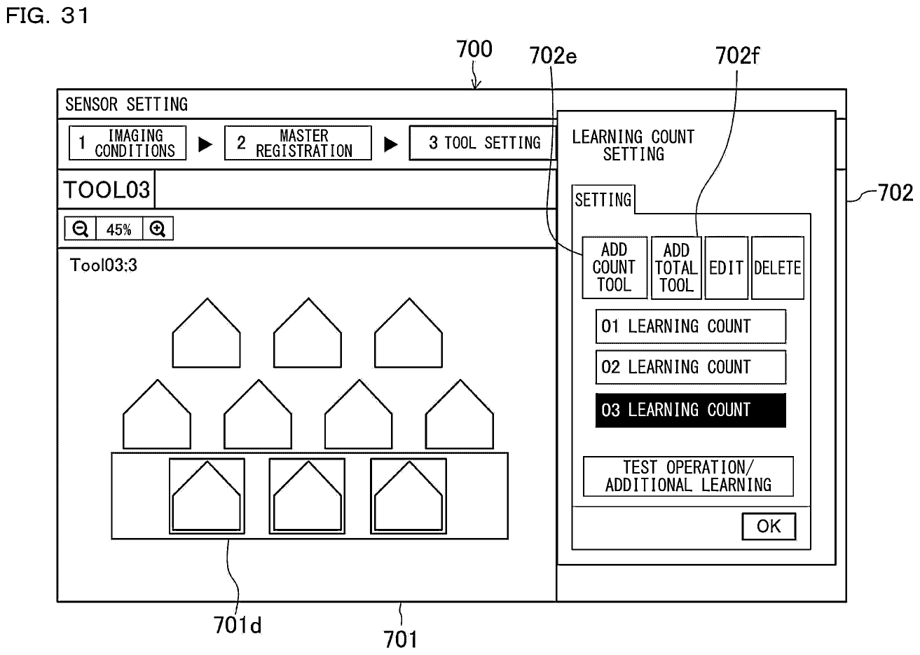

FIG. 31 shows specific display examples when learning count tools are set for the upper section, middle section, and lower section, respectively. “01” is the learning count tool set in the upper section, “02” is the learning count tool set in the middle section, and “03” is the learning count tool set in the lower section. When adding a learning count tool, the count tool add button 702e should be operated. When the control unit 21 detects that the count tool add button 702e has been operated, it adds a new learning count tool.

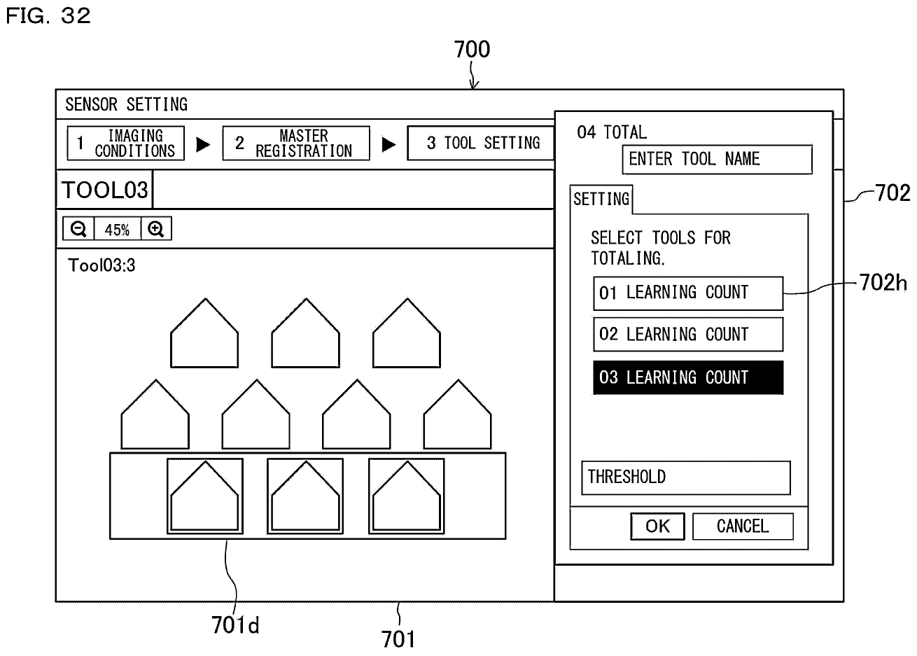

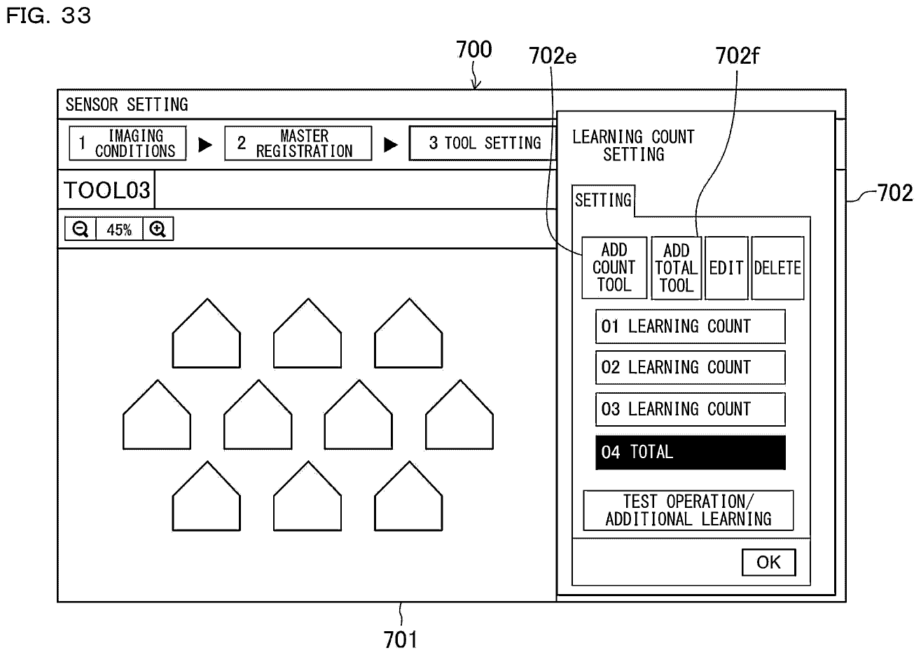

In the case of setting a total tool to sum the judgment results of these three learning count tools, the total tool add button 702f should be operated. When the control unit 21 detects that the total tool add button 702f has been operated, it displays the checkbox 702h corresponding to the learning count tools to accept selection operations by the user, as shown in FIG. 32. The learning count tools checked in the checkbox 702h are subject to the totaling process by the total tool. In this example, three learning count tools are subject to the totaling process by the total tool. Furthermore, when using the total tool, it is also possible to set the upper and lower limits of the count number using the setting window 760 for setting, as shown in FIG. 22. As shown in FIG. 33, after setting the total tool, the total tool is displayed along with the learning count tools, allowing the user to confirm the setting states of both the total tool and the learning count tools.

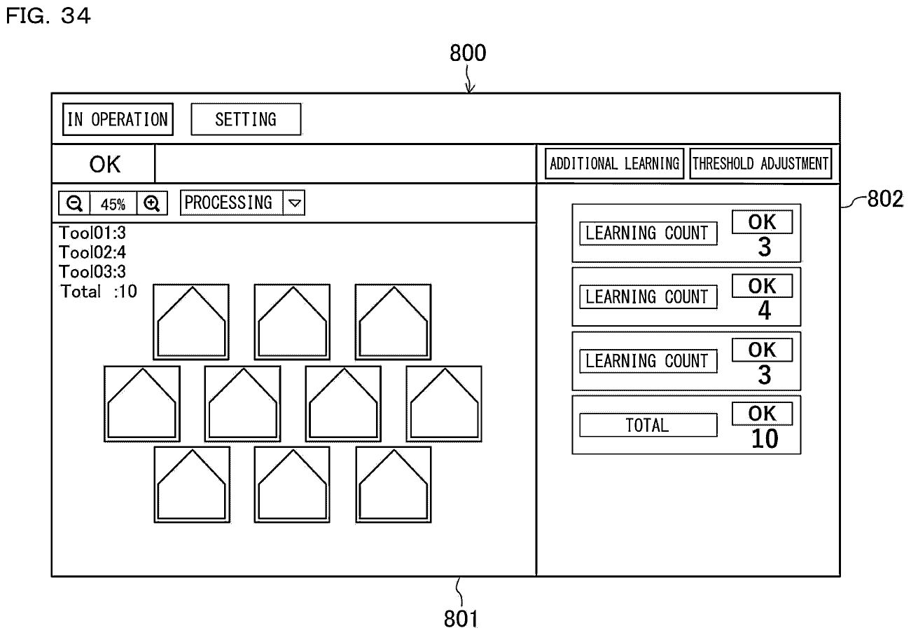

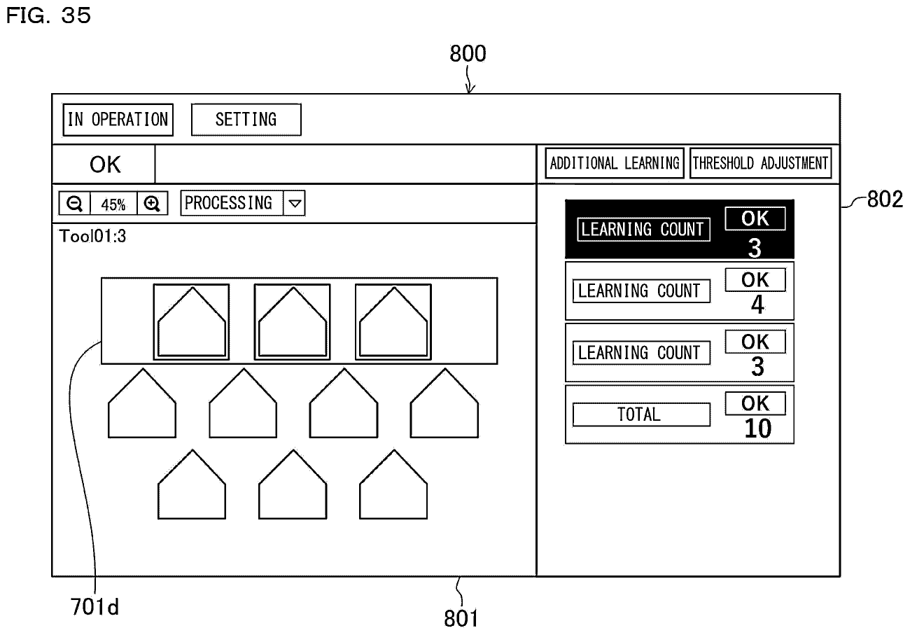

FIG. 34 is a diagram showing an example of the operation screen 800 displayed during the operation of the total tool. As shown in this figure, the judgment results of three learning count tools are displayed individually, along with the judgment result of the total tool. For example, when the user selects the upper learning count tool, as shown in FIG. 35, the control unit 21 displays the fourth box 701d indicating the search range of the upper learning count tool on the display device 4, allowing the user to easily grasp where and how the learning count tool is set on the image.

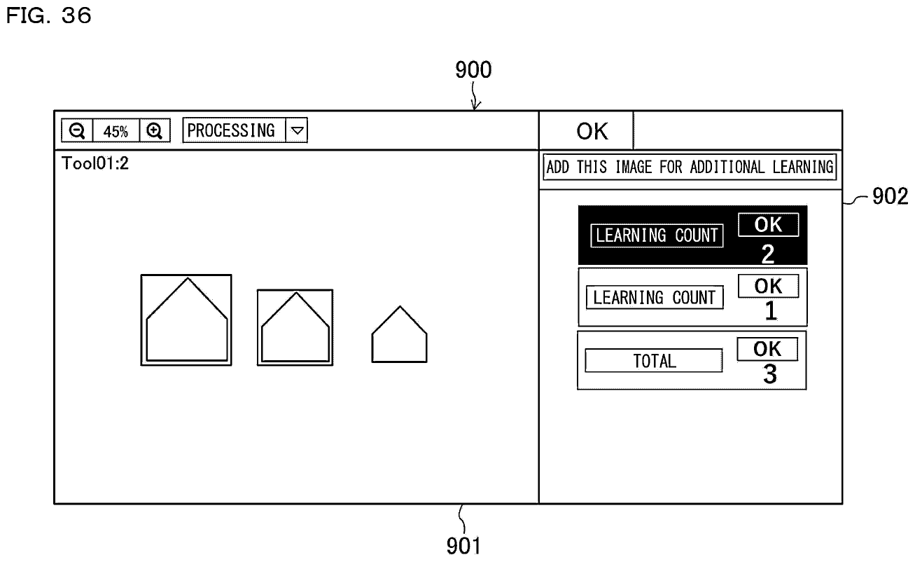

When multiple learning count tools are set, the control unit 21 has a function to eliminate duplicate detection between tools. For example, as shown in the image display area 901 in FIG. 36, when learning a model with a large-sized work on the left and a small-sized work on the right, the medium-sized work in the center can be detected by both the tool that detects the large work and the tool that detects the small work. However, in this embodiment, as shown in the result display area 902, the tool that detects the large work (01 learning count) is set to detect the medium-sized work. Therefore, in this example, the work detected by the tool that detects the small work (02 learning count) will be one. This function is particularly effective when sorting works with different postures or sizes, or when learning works with different postures or sizes to determine the total. It is also possible to detect the medium-sized work with the tool that detects the small work, in which case the work detected by the tool that detects the large work will be one.

For example, when all target objects cannot be correctly detected with one tool, it is conceivable to set two types of tools in the same area. In this case, if there are target objects detected by both tools, it will result in double counting; however, in this example, since duplicates can be removed based on the detection location, it is possible to count all target objects with multiple tools while avoiding duplication in terms of numbers.

### Missing Detection Function

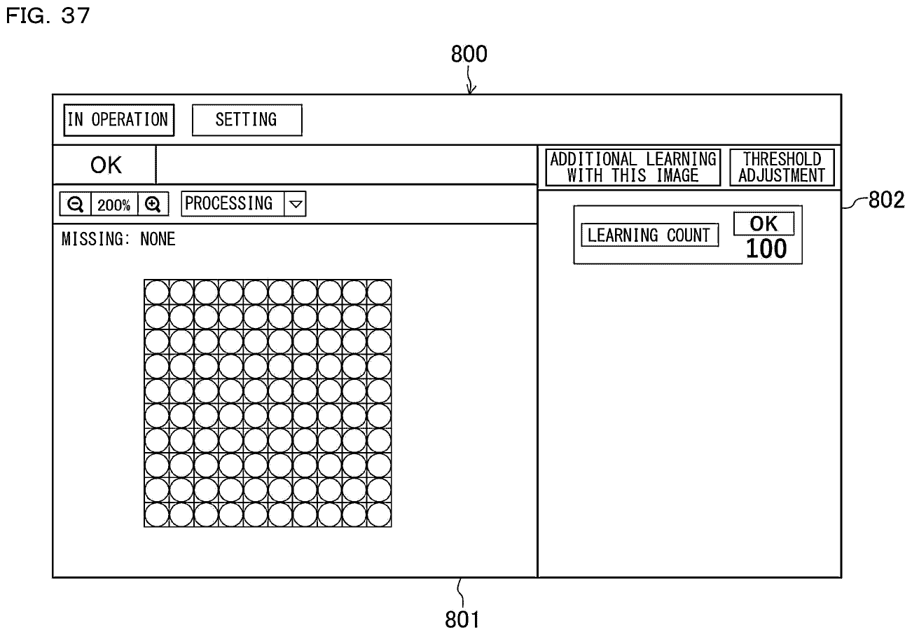

The image inspection device S has a function to detect when some of the multiple workpieces are missing when inspecting them, for example, when they are lined up. FIG. 37 shows the case where an image captured when the workpieces are arranged vertically in 10 and horizontally in 10 is input. In this case, the count number is 100, which is acceptable.

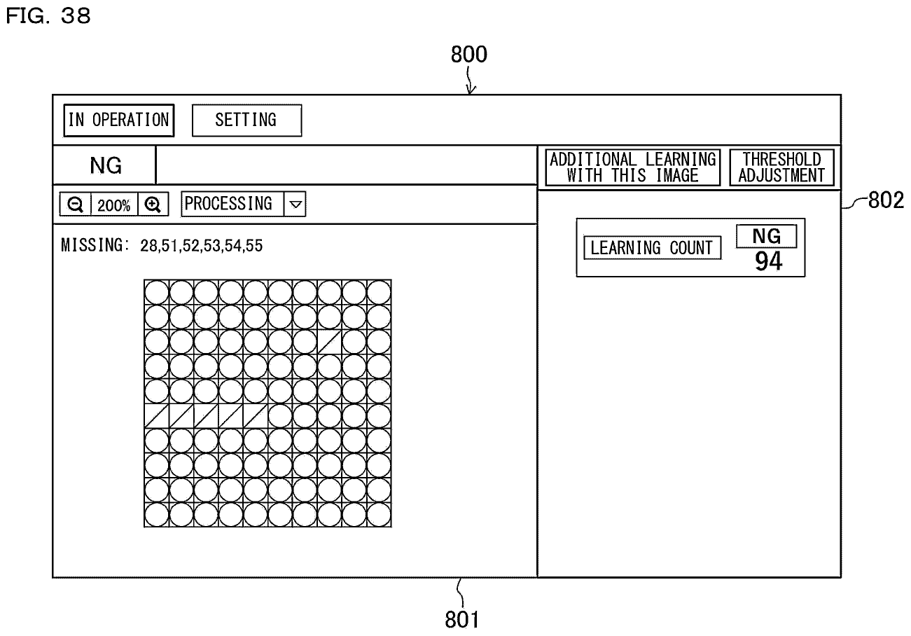

On the other hand, FIG. 38 shows a case where an image captured when six out of one hundred works are missing is input. In this case, the count number is 94, and the control unit 21 detects that the works are missing and determines it as defective, displaying it in the result display area 802. When some works are missing, the numbers of the missing locations are displayed in the image display area 801. That is, since there are ten arranged vertically and horizontally, the control unit 21 assigns numbers from 1 to 100 in order, for example, from the top left to the bottom right, and displays the numbers of the locations determined to be missing in the image display area 801. This allows the user to easily identify which works are missing.

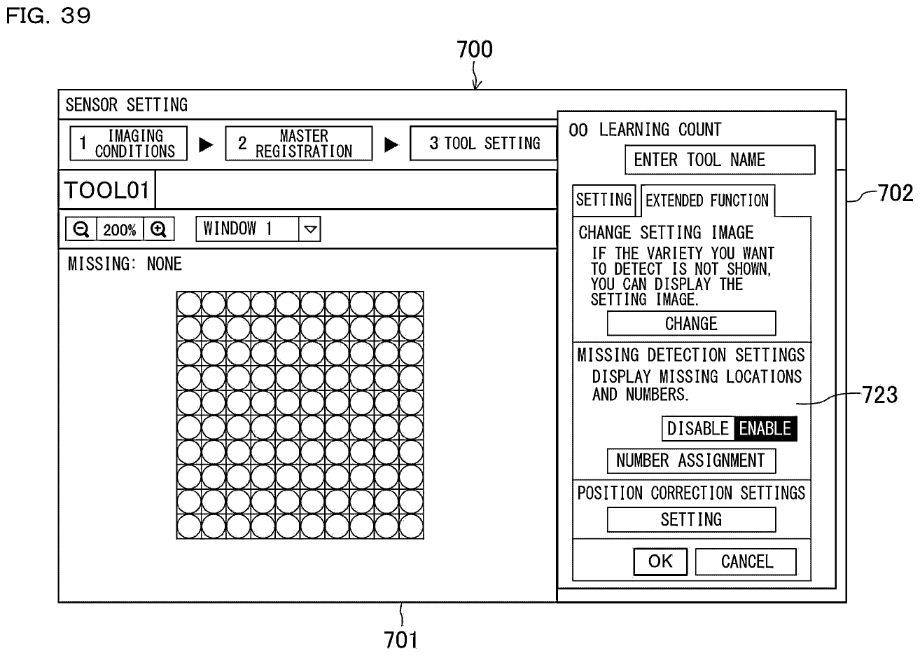

In order to enable the missing detection function, the activation setting is performed in the missing detection settings area 723 shown in FIG. 39. The missing detection settings area 723 is classified as an extended function. When the control unit 21 detects that the user has operated the extended function tab, it displays the missing detection settings area 723 on the display device 4.

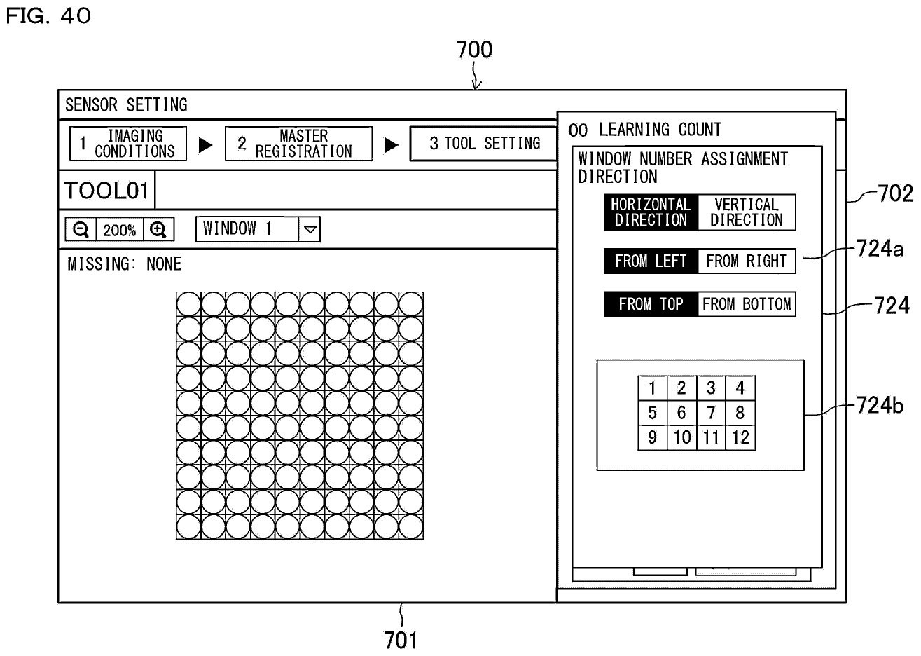

During the setting of the missing detection function, number assignment settings are also performed for each of the multiple works. FIG. 40 shows a case where the number assignment setting window 724 is displayed. The number assignment setting window 724 is provided with a rule setting area 724a for setting the assignment rules and a number display area 724b that schematically shows the arrangement of the assigned numbers. The number assignment rules can be set in detail, such as vertical and horizontal, left and right, and up and down, or it can be a simple setting that only specifies the priority direction, such as vertical direction and horizontal direction.

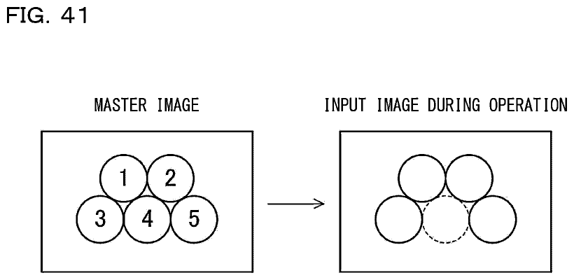

The specific method of missing detection will be explained based on FIG. 41. As a master, an image is assumed in which five circular works are arranged. The five works are assigned numbers 1 to 5 according to the aforementioned assignment rules. In the input image entered during operation, the fourth work is missing. The control unit 21 seeks the correspondence between the master and the input image, determines the locations where there is no corresponding item as the places where the work is missing, and presents this to the user.

The aforementioned embodiments are merely illustrative in all respects and should not be interpreted restrictively. Furthermore, any modifications or changes that fall within the equivalent range of the patent claims are all within the scope of the present invention.

As described above, the image inspection device according to the present disclosure can be used for inspecting various works.

What is claimed is:

1. An image inspection device in which a pre-trained model is executed to detect a target object in an input image data, comprising:
a control unit configured to execute the pre-trained model and to function as a learning data setting unit configured to set learning data for on-site learning of the pre-trained model, and a learning execution unit configured to execute updating of the pre-trained model based on the learning data, wherein
the pre-trained model includes;
a feature extraction unit that configured to extract a feature from the input image data, the feature indicating a characteristic of an image data, and
a classification unit that configured to output a class to which an image area of the image data belongs based on the feature to detect the target object in the image data, the feature being extracted by the feature extraction unit, wherein
the learning data setting unit includes;
a setting screen display unit configured to display a setting screen including a setting image display area for displaying a setting image on a display device,
a candidate region estimation unit configured to estimate a candidate region of the setting image, and
a learning data generation unit configured to generate the learning data based on the setting image and the estimated candidate region, and
the candidate region estimation unit estimates a second candidate region when a re-estimation instruction is received while the setting screen display unit is displaying the position of a first candidate region superimposed on the setting image, the first candidate region being estimated by the candidate region estimation unit, the re-estimation instruction being an instruction to execute an estimation of the candidate region, and the second candidate region being estimated such that the second candidate region being different from the first candidate region,
the learning data generation unit generates the learning data based on the setting image, the first candidate region, and the second candidate region, and
the learning execution unit updates the pre-trained model to classify the candidate region into the class of the target object based on the learning data.

2. The image inspection device described in claim 1, wherein:
the setting screen display unit displays the second candidate region in a manner different from the first candidate region.

3. The image inspection device described in claim 2, wherein:
the learning data setting unit changes the manner of the first candidate region by the setting screen display unit when receiving the re-estimation instruction.

4. The image inspection device described in claim 1, wherein:
the learning data setting unit receives a user-designated region based on user designation for setting image data displayed in the setting image display area, and
the setting screen display unit displays the user-designated region and the candidate region in different manners.

5. The image inspection device described in claim 1, wherein:
the learning data setting unit receives a deletion instruction for the candidate region displayed by the setting screen display unit
and stores the deleted candidate region as a deletion setting position, and
the candidate region estimation unit estimates the candidate region so that the position of the estimated candidate region is not same as the deletion setting position.

6. The image inspection device described in claim 1, wherein:
the candidate region estimation unit
estimates a region having a feature quantity similar to a first reference feature quantity as the first candidate region, and
estimates a region having a feature quantity similar to a second reference feature quantity as the second candidate region, the second reference feature corresponding to the first candidate region displayed when the candidate region estimation unit receives the re-estimation instruction.

7. The image inspection device described in claim 1, wherein:
the candidate region estimation unit
estimates a region having a similar feature quantity to a reference feature quantity within a certain range as the first candidate region, and
estimates a region having a similar feature quantity to the reference feature quantity within an expanded range compared to the certain range as the second candidate region.

8. The image inspection device described in claim 1, wherein:
the candidate region estimation unit
estimates a region having a similar feature quantity to a first reference feature quantity within a certain range as the first candidate region, and
estimates a region having a similar feature quantity to a second reference feature quantity within an expanded range compared to the certain range, the second reference feature quantity corresponding to the first candidate region displayed when the candidate region estimation unit receives the re-estimation instruction.

9. The image inspection device described in claim 1, wherein:
the learning execution unit updates the pre-trained model so as to classify the candidate region into the class of the target object and classify the area other than the candidate region into the class of the background.

10. The image inspection device described in claim 9, wherein:
the learning execution unit learns a boundary configured to separate the class of the target object and the class of the background, and
the pre-trained model detects the target object in an inference image data based on the feature and the boundary.
